(19) United States
(12) Patent Application Publication
(10) Pub. No.: US 2024/0289645 A1
(43) Pub. Date: Aug. 29, 2024

(54) SYSTEM AND METHOD OF REGRESSION BASED MACHINE LEARNING MODELS FOR PREDICTIVE INSIGHTS

(71) Applicant: THE TORONTO-DOMINION BANK, TORONTO (CA)

(72) Inventors: SAMIKSHA MAKHIJANI, TORONTO (CA); SANGEETA MATHEW, MISSISSAUGA (CA); DALBIR CHANNA, MARKHAM (CA); FARNUSH FARHADI HASSAN KIADEH, TORONTO (CA); JIANING SUN, TORONTO (CA); SABA ZUBERI, TORONTO (CA); LINDA LING TAO, TORONTO (CA)

(21) Appl. No.: 18/534,502

(22) Filed: Dec. 8, 2023

Related U.S. Application Data
(63) Continuation-in-part of application No. 18/173,878, filed on Feb. 24, 2023.

(51) Int. Cl. G06N 5/022

(52) U.S. Cl. CPC G06N 5/022

(57) ABSTRACT

The disclosed embodiments include computer-implemented systems, apparatuses, and processes that automatically generate and provision a system of machine learning models specifically configured and trained for providing a signal output indicative of a prediction and associated confidence metrics derived via retraining the prediction model for providing the initial prediction and comparing outputs of the set of machine learning models to expected thresholds for the prediction and generating, based on the comparison, a set of actions to be performed on a networked computing environment relating to one or more transactions associated with the prediction.

### CROSS-REFERENCE TO RELATED APPLICATIONS

This application is a continuation-in-part of, and claims priority from, U.S. Patent Application No. U.S. Ser. No. 18/173,878, filed Feb. 24, 2023, and entitled “SYSTEMS AND METHODS FOR AUTOMATICALLY GENERATED DIGITAL PREDICTIVE INSIGHTS FOR USER INTERFACES”; the entire contents of which are hereby incorporated by reference herein.

### FIELD

The present disclosure relates to systems of machine learning models, for example configured for enhanced predictive digital content and more particularly to a particular set of machine learning models for predicting confidence of the prediction and generating associated computerized actions.

### BACKGROUND

Application users using online transaction applications, websites and computing resources have a need for personalized online information when accessing the software applications and websites. Current approaches provide differing quantified insights lack trust of end users as they often utilize black box or ad-hoc methods to offer any insights and lack personalization. Additionally, current approaches lack ability to be multi-dimensional and process different types of information, thereby being inaccurate and incomplete.

In addition, many approaches may also be computationally intensive and require significant analysis as they lack reasoning or transparency for any digital content provided and thus, they are less likely to be implemented and engaged as their information lacks trust and reliability. Conventional digital content distribution systems are inflexible and unable to adjust to changing needs of networked client systems and data transfer environments. Additionally, providing inaccurate digital content in networked environments can render user interfaces and the associated computing applications or websites obsolete, ineffective and waste unnecessary computing resources.

### SUMMARY

Computational systems, methods, devices and techniques are disclosed in various embodiments whereby computing systems are configured to automatically provide transaction related digital content including insight information and future predictive performance metrics for the transactions to an interactive user interface (e.g. a graphical user interface) of a client device. The disclosure also provides, in at least some embodiments, computing systems, device and methods configured to provide digital icons on a graphical user interface (GUI) of a computer system with personalized user insights and presenting icons with associated digital actions based on the predicted insight information.

In at least some aspects, there is also a need to improve performance and application of machine learning systems used in networked computing environments to generate relevant digital actions and content.

In at least some aspects, the systems, methods, and computing devices provide an improved system of connected machine learning models cooperating together and configured together in a particular manner of training and retraining for providing concurrently a prediction of a target variable or attribute of interest and associated confidence scores generated for the prediction based quantile regression prediction of upper and lower bound predictions and triggering computerized actions within a networked system of computers based on one or more trigger conditions determined from the confidence score being met. Such triggering of computerized actions based on one or more conditions being met (e.g. meeting and/or exceeding a desired confidence threshold in the prediction) may include generation of content and controlling digital transactions between devices within a networked system of computing devices (e.g. a prediction engine, a content delivery system, one or more client devices, and a data processing server).

In at least some implementations, end users and client devices using online applications and computing resources have a need for enhanced personalized digital content insights into historical and future forecasted or predicted digital events or transactions between devices. Additionally, in some aspects, such insights need to convey the computing methods and systems by which such a predicted insight was deduced so that they may be trusted and interacted with on a user interface. Additionally, in at least some aspects, there is a need to provide graphical user interface content and associated interface icons providing insights such as relating to digital assets which do not simply focus on a single dimension of information without adequately analysing or proving insights on other dimensions of transaction data.

In at least some aspects, there is provided a plurality of regression based machine learning models specifically coupled and configured in a particular manner to cooperate together in series of training and retraining iterations to provide multiple prediction attributes and deliver a confidence metric of predicted digital content (e.g. digital icons for performing computerized actions; digital resources; or digital information for performing subsequent between networked computing devices) in order to determine subsequent computerized actions, which may be displayed on one or more associated computing devices for performing transactions between a source and computing device(s).

Additionally, there is a need, in at least some aspects, to provide a computing system and method which may be configured to alter the type of digital content (e.g. available computerized actions and associated icons displayed or allowed by a client computing device) provided to end users based on predicted future digital transactions and a confidence score or confidence metric predicted from the predicted future digital transactions. Thus, in at least some aspects, computing systems and methods allow specific operations or content which may be made available to certain devices or groups of devices based on a prediction of a future event and a confidence metric derived for the prediction from a plurality of specifically configured machine learning models.

In at least some aspects, there is provided a computer tool and interface in a networked environment that assesses historical transaction behaviours and activities associated with one or more computing devices and predicts future digital events in a networked computing environment, e.g. digital transactions, as well as confidence score derived using regression based machine learning models configured particularly to determine the confidence for the prediction such as to push or provide computerized operations (e.g. by way of a user application or interface)

In addition, in at least some aspects, the computer tool may provide predictive insights at a high level of accuracy that allows for a detailed display of predictive insights.

In some aspects, there is provided a plurality of coupled context-aware machine learning computer models which may cooperate together to analyze past individual transaction behaviours in order to contextualize the transactions, predict future data transfers and associated confidence score prediction (e.g. by way of upper bound quantile and lower bound quantile regression prediction) and provide customized digital content including computerized actions made available to computing devices via user interface icons based on the confidence score predicted. Aspects of the disclosure may use a combination of mixed machine learning models for different types of data transfer predictions to increase the accuracy of the predictions compared to prior methods.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a system of machine learning models and comprises: a first prediction model trained via a set of historical features for predicting a future target value of a target variable at a future time from a current time having a related set of features and applying regression learning for predicting based on an initial loss function; a second prediction model coupled to the first prediction model once already trained, the second prediction model for retraining the first prediction model, via configuration engine, in a subsequent iteration based on an updated regression loss function being weighted by an upper bound metric for applying quantile regression for predicting an upper bound quantile of the target variable being predicted; a third prediction model coupled to the first prediction model once already trained, the third prediction model retraining the first prediction model in a further subsequent iteration, via the configuration engine, based on the updated regression loss function weighted by a lower bound metric for applying quantile regression for predicting a lower bound quantile of the target variable being predicted.

The system may also include a confidence predictor module, coupled in communication with the first prediction model, the second prediction model and the third prediction model for receiving a range of outputs relating to the variable may include the upper bound quantile, the lower bound quantile and the target value of the target variable and for predicting as a function therefrom, an output signal indicative of a confidence score. The system also includes an action generation module coupled to the confidence predictor module for processing the output signal from the confidence predictor module and based on comparing the output signal to an expected signal threshold, triggering generation of a set of actions performed by the system on at least one associated computing device when processing transaction records associated with the target variable. Other embodiments of this aspect include corresponding computer systems, apparatus, and computer programs recorded on one or more computer storage devices, each configured to perform the actions of the methods.

Implementations may include one or more of the following features.

In one or more implementations of the system, the confidence predictor module determines the confidence score by applying:

$$Confidence = \frac{\hat{y}}{\vert upper bound - lower bound} = \frac{\hat{y}}{\vert {\hat{y}}_{upper} - {\hat{y}}_{lower} \vert}$$

where “ŷ” is prediction output of the first prediction model, “ŷᵤₚₚₑᵣ” is the upper bound quantile provided as output of the second prediction model and “ŷ_{lower}” is the lower bound quantile of the target variable provided as output of the third prediction model.

In at least some aspects, the action generation module is in communication with the confidence predictor module, for triggering generation of a particular action upon receiving an indication of the output signal on the at least one associated computing device in response to detecting subsequent transactions on the at least one associated computing device related to the target variable, the actions retrieved from a confidence score repository based on a degree of confidence determined as a degree of deviation of the confidence score relative to the expected signal threshold.

In at least some aspects, the third prediction model may be configured, via the configuration engine, to increase a hyperparameter in the updated regression loss function of the third prediction model to penalize more on overestimated predictions to determine the lower bound quantile of the target variable.

In at least some aspects, the second prediction model may be configured, via the configuration engine, to decrease the hyperparameter associated with the second prediction model to penalize more on underestimated predictions to determine the upper bound quantile of the target variable.

In at least some aspects, the second and third prediction models may be configured for retraining an existing machine learning prediction model provided by the first prediction model to cooperate together to determine a measure of confidence associated with predicting the future target value of the target variable, wherein the existing machine learning prediction model applies, via the configuration engine, a squared error prediction having a squared error loss objective defined by: L=(y−Xθ)², wherein y represents actual values of the target variable and Xθ represents predicted values, the loss function used to optimize the first prediction model to predict the future target value of the target variable.

In at least some aspects, the second prediction model and the third prediction model are configured for adjusting a prior trained machine learning prediction model provided by the first prediction model to optimize a quantile loss function defining the updated regression loss function, wherein the quantile loss function is defined by:

$$L = \{ \begin{matrix}τ ( y - X θ ) , & if y - X θ \geq 0 \\ ( τ - 1 ) ( y - X θ ) , & if y - X θ < 0\end{matrix}$$

wherein τ∈(0, 1) specifies the tth quantile of interest, y is actual (e.g. ground truth) value of the target variable, Xθ is a hypothesis function defining prediction performed by a respective model which uses extreme gradient boosted (XGBoost) as a learning algorithm.

In at least some aspects, the configuration engine is configured to set the quantile of interest to t=0.05 for the lower bound metric to predict the lower bound quantile variable and set the upper bound metric to t=0.95 for predicting the upper bound quantile variable.

In at least some aspects, the first prediction model, the second prediction model and the third prediction model are extreme gradient boosted models.

In at least some aspects, the action generation module is configured to perform the action may include displaying actionable icons on a graphical user interface on a particular client device of the at least one associated computing device for modifying subsequent transactions between the particular client device and one or more other computing devices across a communication network.

In at least some aspects, the action generation module is configured, based on the confidence score determined to push out a signal indicative of the target variable predicted to only a selected set of client computing devices based on the confidence score having beyond a defined amount above the expected signal threshold as retrieved from the confidence repository, along with the actionable icons displayed concurrently on the graphical user interface of the selected set of client computing devices.

Implementations of the described techniques may include hardware, a method or process, or computer software on a computer-accessible medium.

One general aspect includes a computer implemented method also includes training a first prediction model via a set of historical features for predicting a future target value of a variable at a future time from a current time having a related set of features and applying regression learning for predicting based on an initial loss function; generating a second prediction model coupled to the first prediction model once already trained; retraining, via a configuration engine, the first prediction model to generate the second prediction model in a subsequent iteration based on an updated regression loss function being weighted by an upper bound metric for applying quantile regression for predicting an upper bound quantile of the target variable being predicted; generating a third prediction model coupled to the first prediction model once already trained; retraining, via the configuration engine, the first prediction model to generate the third prediction model in a further subsequent iteration based on the updated regression loss function weighted by a lower bound metric for applying quantile regression for predicting a lower bound quantile of the target variable being predicted; and applying a range of outputs relating to the variable may include the upper bound quantile, the lower bound quantile and the target value to a confidence predictor module coupled in communication with the first prediction model, the second prediction model and the third prediction model, to predict as a function therefrom, an output signal indicative of a confidence score; processing, by an action generation module coupled to the confidence predictor module, the output signal, for processing and based on comparing the output signal to an expected signal threshold, triggering generation of a set of actions performed by a processor on at least one associated computing device when processing transaction records associated with the target variable. Other embodiments of this aspect include corresponding computer systems, apparatus, and computer programs recorded on one or more computer storage devices, each configured to perform the actions of the methods.

One general aspect includes a tangible computer readable medium also includes training a first prediction model to generate a trained model via a set of historical features for predicting a future target value of a variable at a future time from a current time having a related set of features and applying regression learning for predicting based on an initial loss function; generating a second prediction model coupled to the first prediction model once already trained, retraining the first prediction model to generate the second prediction model in a subsequent iteration based on an updated regression loss function being weighted by an upper bound metric for applying quantile regression for predicting an upper bound quantile of the target variable being predicted, generating a third prediction model coupled to the first prediction model once already trained, retraining the first prediction model to generate the third prediction model in a further subsequent iteration based on the updated regression loss function weighted by a lower bound metric for applying quantile regression for predicting a lower bound quantile of the target variable being predicted. The tangible also includes apply a range of outputs relating to the variable may include the upper bound quantile, the lower bound quantile and the target value to a confidence predictor module coupled in communication with the first prediction model, the second prediction model and the third prediction model, to predict as a function therefrom, an output signal indicative of a confidence score; and, process the output signal at an action generation module couple to the confidence predictor module, for processing and based on comparing the output signal to an expected signal threshold, triggering generation of a set of actions performed by a processor on at least one associated computing device when processing transaction records associated with the target variable.

Other embodiments of this aspect include corresponding computer systems, apparatus, and computer programs recorded on one or more computer storage devices, each configured to perform the actions of the methods.

Implementations of the described techniques may include hardware, a method or process, or computer software on a computer-accessible medium.

### BRIEF DESCRIPTION OF THE DRAWINGS

These and other features of the disclosure will become more apparent from the following description in which reference is made to the appended drawings wherein:

FIG. 1A shows an example schematic block diagram of a computing environment including a computerized content delivery system utilizing a neural network framework, according to one embodiment.

FIGS. 1B and 1C illustrate example predictive machine learning model generation and training parameters including target definition and training/test/validation data splitting, according to one embodiment.

FIG. 1D is an example schematic block diagram of computing components of a prediction engine of FIG. 1D in communication with computing components of the content delivery system of FIG. 1D, according to one embodiment.

FIG. 2 illustrates a schematic diagram of an example process for generating predictive insights, nudges and personalized actions on an example generated graphical user interfaces (GUI) or portions thereof as may be generated by the computerized content generation system of FIG. 1A, according to one embodiment.

FIGS. 3, 4A-4C, and 5A-5B are diagrams illustrating example graphical user interfaces generated by the computerized content delivery system of FIG. 1A, according to various example embodiments.

FIG. 6 illustrates an example flow of operations for the content delivery system of FIG. 1A, according to one embodiment.

FIG. 7 illustrates an example flow of operations for the prediction engine of FIG. 1D, according to one embodiment.

FIG. 8 illustrates an example graph of quantile loss by error and quantile prediction, according to one embodiment.

FIG. 9 illustrates an example prediction output result for a particular variable of interest on a set of random sampled accounts in out of time validation set, according to one embodiment.

### DETAILED DESCRIPTION

Generally, in one implementation, there is provided a computer method and system using predictive machine learning for monitoring data transfers and transaction activity relating to one or more computer devices and associated data as may be stored within central database systems and database records, including customer data records and generating customized user interfaces based on predictive modelling which display data transfer trends, behaviours and expected future trends as well as electronic or digital objects providing insight content generated on user interfaces and corresponding electronic action icons for performing actions, such as to improve the data transfer patterns predicted. In one implementation, the proposed system and method monitors and analyses changes to one or more database records within one or more database system relating to data transfers, such as customer data records including account balances and associated data including transactions between one or more computing devices in a networked computing environment. In one example, the data transfer records may relate to debiting and crediting the one or more customer data records. In at least some implementations, the data transfers being tracked between computing devices such as within data transfer records of database systems may be applied to a neural network model configured to predict future data transfers and determine insights, based on other user behaviours monitored and tracked to improve the data transfers and when interacted with, such insights on a particular user interface device, are configured to trigger subsequent actions on the customized user interface for improving the data transfer patterns in a subsequent time period. For example, such data transfers may be applied, in at least some aspects to a neural network configured to predict data transfers including future cash-flows and provide data transfer insights, e.g. cash-flow insights on to customers as well as corresponding computerized actions, displayed in the form of one or more selectable computer icons on the generated graphical user interface via one or more screens relating to the insights from the predictive modelling, such as for improving such trends predicted from the models.

In at least some implementations, the present disclosure relates to systems, methods, and non-transitory computer readable media for utilizing an artificial intelligence framework, including a set of neural network models for predicting different types of data transfers over a future time period and for generating enhanced digital content on interactive graphical user interfaces of computing devices including digital insights and selectable actions based on the predictions for improving the predictions in a subsequent time interval or iteration.

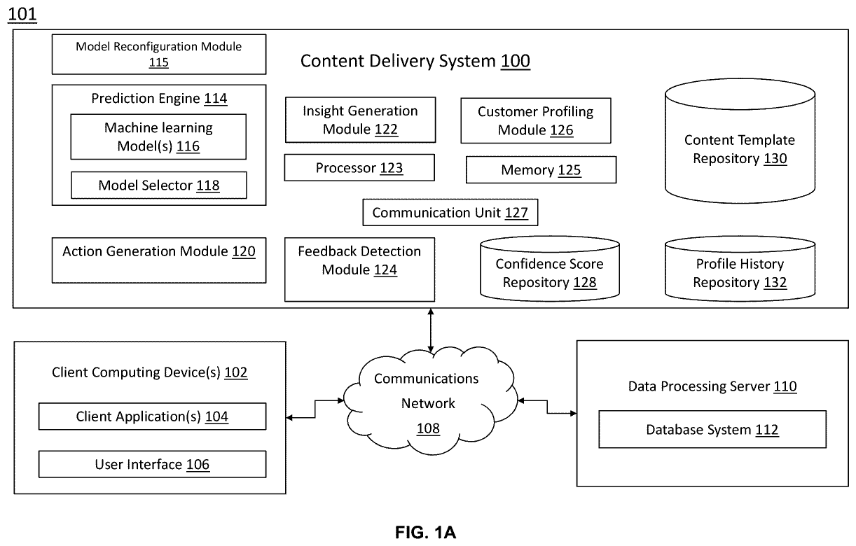

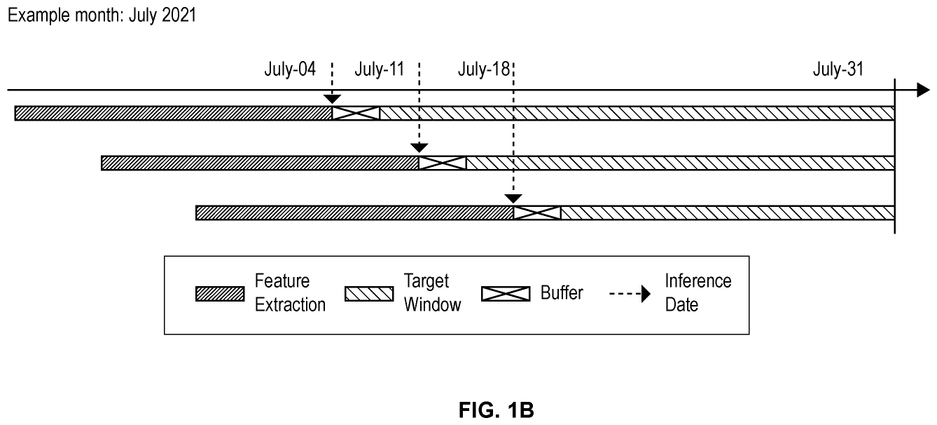

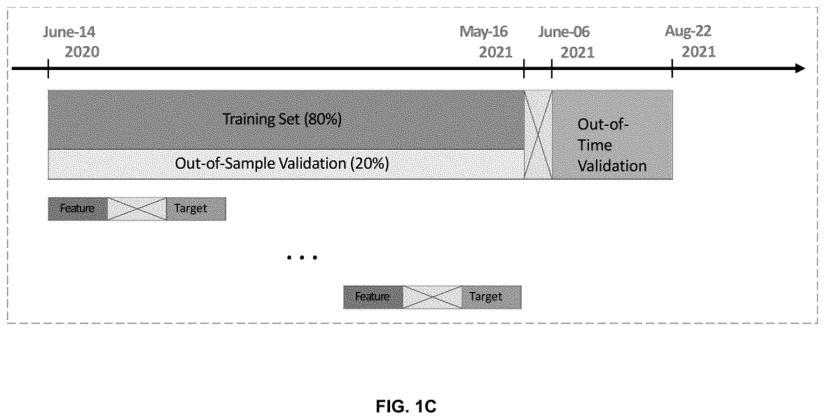

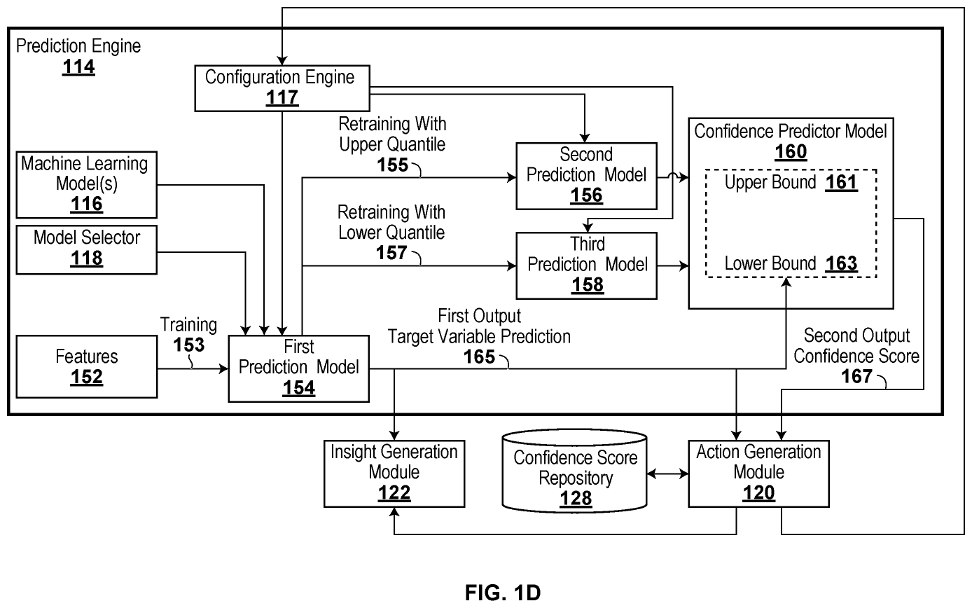

Referring to FIG. 1A, shown is a schematic diagram of an example computing environment for implementing a digital content delivery system 100, in accordance with one or more embodiments configured to determine and generate customized digital content on associated customized graphical user interfaces, such as client computing devices 102, using an artificial intelligence framework. In particular, the digital content may comprise predictive content such as performance metrics relating to data transfers in a future time period, and metadata defining at least one reasoning for the prediction and digital actions delivered for presentation onto graphical user interfaces of the one or more associated computing devices, such as client computing devices 102, across one or more communications network 108. As illustrated in FIG. 1A, the content delivery system 100 may communicate with a data processing server 110, and one or more client computing devices 102, across a communications network 108. For example, in one implementation, the data processing server 110 may comprise one or more processors, a memory storing processor executable instructions and a database system 112 managed by the processors. Additionally modules of the data processing server 110 are not shown to avoid undue complexity of the drawings. The database system 112 may store data records relating to data transfers, such as transactions between different clients on associated client computing devices 102 including from a source to a destination. Such data record transactions may include in one example use, data relating to payment systems and communications between client computing devices 102 with data records held on each devices and with data records on other devices (e.g. between merchant engine and client computing device 102). In one implementation, the database systems 112 may include data records relating to cash flows, and cash flow attributes (e.g. fixed or variable expenses; types of merchant, etc.) for each transaction on each of the data records on the client computing device 102 as may be held for a particular entity of interest for which the client application 104 is configured to display digital content relating to data records for the client computing device 102 with the assistance of the content delivery system 100 providing dynamic, and real-time content including predictive content for display on a user interface 106 associated with the client application 104.

In one example implementation, the data processing server 110 tracks and stores within the database system 112, changes or indications of data transfers for one or more client computing devices 102, associated data transfers and attributes (e.g. a type of data transfer such as variable, fixed or continuous, data relating to a source or destination devices for the transfer, frequency of transfer, quantity of transfer, associated computing devices within the networked environment of FIG. 1A performing the data transfers, and associated e-commerce objects or products related to the transfer, etc.). Such data transfers may include transactions between client computing devices 102 or transactions between different data records within a particular client computing device 102 and client application 104.

In one example, the data transfer data stored within the database system 112, may include data records containing data transfer changes. In one example, this may include data records for data transfer changes such as relating to transaction changes including cash flow changes, cash flow attributes (e.g. fixed or variable expenses or other categorization of the data transfer), for one or more customer account balances including increases or decreases in account balance as performed by and relating to client computing devices 102. Additionally, in some aspects, the data records for data transfers may include associated data relating to transactions between a source and a destination, e.g. debiting and crediting the one or more customer data records being tracked. Attributes for the data transfers being monitored, tracked and stored within the data processing server 110 may include data and information relating to the source, frequency, and quantity of data transfers; and the frequency, quantity, and e-commerce objects involved in the data transfer).

Although one example implementation of the disclosed methods and systems may relate to data transfers relating to financial transactions and associated attributes for the transactions, other types of electronic data transfers, such as by one or more client computing devices 102 across the communications network 108, may be monitored, tracked and used for prediction of output signals indicative of attributes related to the data transfers and associated digital computerized actions generated by the prediction system including predictive digital content by the content delivery system 100 and associated actions for display on a customized graphical user interface of the client computing device 102. Such digital data transmission signals may be sent and received using a digital format suitable for transmission such as binary code across the network and computing environment of FIG. 1A and decoding it at the receiving end. Therefore, in at least some aspects, the data processing server 110 may include processors, memory and instructions for implementing one or more transaction systems for processing and analyzing data transfers in the environment of FIG. 1A, including but not limited to, data communication systems, social networking systems, e-commerce transaction systems, data security systems, digital asset systems, financial transaction systems, and may use different storage systems along with the database system 112, and associated authentication, security and formatting techniques, and/or various different techniques for processing the transaction data including based on the respective characteristics of the hardware and/or software system(s) used within the environment of FIG. 1A.

The content delivery system 100 may analyze, decode and process secure data transfers and other transaction related data (e.g. including monitoring online behaviour of users interacting with client applications 104 on the client computing device 102 and/or interacting with other computing devices 102 and data processing server 110 to perform transactions) within various computing and networking environments, such as the environment of FIG. 1A, as retrieved by and/or otherwise accessed from data processing server 110. In some example aspects, the content delivery system 100 may be configured to only track and monitor data transfers for digitally active users of client computing devices 102, such as those having had at least a defined number of digital transactions in a given time period.

The content delivery system 100 comprises a prediction engine 114, a computerized action generation module 120, an insight generation module 122, a processor 123, a feedback detection module 124, a memory 125, a communication unit 127, a customer profiling module 126, a confidence score repository 128, a content template repository 130, and a profile history repository 132. In turn, the prediction engine 114 comprises one or more machine learning model 116, and a model selector 118.

The content delivery system 100 may comprise additional computing modules or data stores in various embodiments. Additional computing modules and devices that may be included in various embodiments, are not shown in FIG. 1A to avoid undue complexity of the description, such as communication with one or more other computing devices, internal communication with various modules, operating system, etc. as applicable, for performing the operations described herein.

Components of the content delivery system 100 may include software, hardware and/or both. One or more processors 123 may implement functionality and/or execute instructions stored within a computer readable storage medium including a memory 125 and/or other computing modules of the content delivery system 100 within a computing device implementing the content delivery system 100. For example, processor(s) 123 may be configured to receive instructions and/or data from storage device(s), including memory 125 and various storage units associated with the modules of the content delivery system 100 to execute the functionality of the modules shown in FIG. 1A, among others (e.g. operating system, applications, etc.). Content delivery system 100 may store data/information (e.g. historical data transfers; historical user interface interactions and patterns; feedback from various client computing devices 102; transactions from data processing server 110; confidence scores generated in accordance with the multiple specifically configured prediction models of FIG. 1D; machine learning configuration engine metadata for the machine learning model(s) of the prediction engine of FIG. 1D; content templates for the digital content generated, etc.) to one or more storage device(s) including but not limited to the memory 125, content template repository 130, profile history repository 132 and confidence score repository 128. When executed by the one or more processors 123, the computer executable instructions stored within the memory 125 and/or other storage modules of the content delivery system 100 may thus cause the content delivery system 100, to perform the methods described herein. That is, the instructions (e.g. as stored within the memory 125) are configured, when executed by the one or more processors 123, to perform any of the methods described herein.

The one or more storage devices, including the memory 125 may take different forms and/or configurations, for example, as short-term memory or long-term memory. Memory 125 may be configured for short-term storage of information as volatile memory, which does not retain stored contents when power is removed. Volatile memory examples include random access memory (RAM), dynamic random access memory (DRAM), static random access memory (SRAM), etc. Memory 125, in some examples, also include one or more computer-readable storage media, for example, to store larger amounts of information than volatile memory and/or to store such information for long term, retaining information when power is removed. Non-volatile memory examples include magnetic hard discs, optical discs, floppy discs, flash memories, or forms of electrically programmable read-only memory (EPROM) or electrically erasable and programmable read-only memory (EEPROM).

One or more communication units 127 may communicate with external computing devices, e.g. other client computing devices 102 and/or data processing server 110 via one or more networks 108 by transmitting and/or receiving control signals; trigger signals for triggering various computerized actions as generated via the prediction engine 114 and the action generation module 120; user interface content and Ul controls for display on associated computing devices as generated via the insight generation module 122, and network signals on the one or more networks. The communication units 127 may include various antennae and/or network interface cards, etc. for wireless and/or wired communications.

Referring back to FIG. 1A, the content delivery system 100 and the data processing server 110 may each represent a computing system that includes one or more computing devices or servers (e.g. not shown in FIG. 1A) such as a special purpose processing device and tangible, non-transitory memory devices storing executable code and application modules for perform the functions described herein.

Other examples of the content delivery system 100 may be a specialized computer including but not limited to: a tablet computer, a personal digital assistant (PDA), a laptop computer, a tabletop computer, a portable media player, an e-book reader, a watch, a customer device, a user device, or another type of computing device configured specifically as described herein to contain hardware and/or software modules to perform the example computing operations described and illustrated modules of FIG. 1A.

Further, the computing devices and servers of the content delivery system 100 may each include one or more processor-based computing devices, which may be configured to execute portions of the stored computer readable code or application modules stored within the content delivery system 100 to perform operations consistent with the disclosed embodiments, including operations consistent with the exemplary processes described herein, which may automatically and dynamically generate or modify digital insight content and trigger generation of one or more graphical user interfaces 106 and user interface controls or content for performing application actions for client applications 104 on external computing devices, and connectivity with one or more additional devices in accordance with monitored data transfers and predictions made by the artificial neural network framework of the content delivery system 100 which may deliver one or more portions of the customized digital content and/or trigger specifically tailored customized computerized actions to dynamically selected network-connected computing devices 102 through corresponding digital signals via the communication unit 127.

The machine learning models 116 may include but not limited to: regression models which define functions to describe relationships between the independent variables and a target variable, rule-based models, decision tree model, and tree based ensemble machine learning models including extreme gradient boosted models applying supervised learning for regression based prediction on the large data sets of data analyzed by the content delivery system 100. Each model 116 may be associated with predicted future performance metrics for a particular type or category of predicted data transfer. Thus, the model selector 118 may be configured to retrieve the data transfer attribute from the data and thereby select the associated model from a plurality of available machine learning models. For example, in the case of data transfers relating to variable expenses, the model selector 118, may select a plurality of extreme gradient boosted regression models based on supervised learning for regression and stored within the machine learning models 116, each trained to output projected variable expenses and an associated prediction interval. In the case of data transfers relating to fixed expenses prediction, the model selector 118 may select rule-based models from the machine learning models 116 specifically configured to output projected fixed expenses, and upcoming data transfers such as including date, merchant, and associated value. In the case of data transfers relating to incoming transactions, such as income, the model selector 118 may select a plurality of extreme gradient boosted regression models to predict projected income and associated prediction intervals. As will be described, at least some of the information generated by the prediction engine 114 may be displayed on the client application 104 via the user interface 106. In at least some implementations, the content delivery system 100 may further manipulate the predicted content from the prediction engine, such as to modify its formatting and presentation and generate associated digital insights and digital actions on the client applications 104.

Thus, the machine learning models 116 may in some aspects utilize supervised machine learning regression model, such as extreme gradient boosted models and be configured to predict future data transfers and transactions, including attributes (e.g. cash-flow associated with the one or more customer accounts held on the database system 112 relating to transactions performed by the client computing devices 102). In at least some aspects, the machine learning models 116 are trained based on prior historical transactions to predict future transaction in a given target window. For example, in the example of financial transactions, the prior transactions may include cash-flow changes and associated data relating to transactions debiting and crediting the one or more accounts.

The machine learning models 116 may thus predict future transactions, transaction attributes for a future time period. In the case of financial transactions, this may include predicting, cash-flow (e.g. net future increase or decrease in the balance of the one or more customer accounts) and cash-flow attributes (e.g. income, fixed expenses, and variable expenses) for a future time period (e.g. a month). For example, the cash flow predictions may include incoming (payroll); fixed expenses and variable expense predictions.

An example of a time schema for target definition of a supervised machine learning model implemented in the machine learning models 116 of FIG. 1A is shown in FIG. 1B, illustrating time windows for feature extraction, a target window, a buffer window and inference dates for prediction of future data transfer targets. Thus, the machine learning model 116 may be constructed such that a target window extends from an inference data (after buffer) to a future time. The model 116 may be run, every periodic time period to predict future data transfers in the target window. Also, a predefined window may be applied for feature extraction based on validating model performance on prior runs of the trained machine learning model.

Additionally, referring to FIG. 1C which illustrates an example data split for training the machine learning model 116 of FIG. 1A and includes out-of sample validation, out-of time validation used for training and generating the machine learning model 116 such as the supervised machine learning model using extreme gradient boosting. As illustrated in FIG. 1C, the training set used to generate the model has a sliding window which moves over a defined period of time, an out of sample set for in-time validation and an out of time set for testing the machine learning model 116. The feature and target windows are also shown as example in FIG. 1C.

Preferably, the machine learning model 116, implements a mixed machine learning model implementation to account for the different types of transaction data attributes and thus performs improved prediction which enables analyzing and processing different types of data based on training the model for that particular type of data. Conveniently, by utilizing a model selector 118 and a plurality of machine learning models 116 (e.g. a set of extreme gradient boosted models) each trained and configured for predicting a future performance metric (e.g. data transfer) for a particular type of data transfer, an improved performance may be reached.

In one aspect, the model 116, once trained may be used to extract therefrom a set of key factors (e.g. based on performing attribute contribution rating of the marginal contribution of attributes such as Shapley contributions) associated with future predicted performance metrics relating to the future data transfer predicted values for various categories.

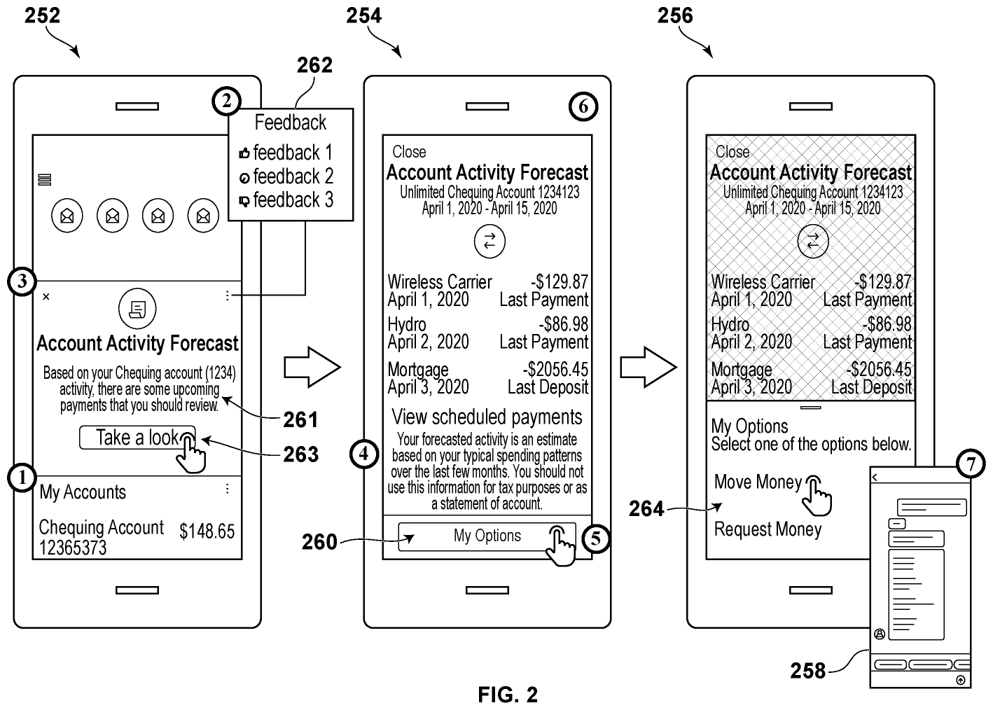

In one particular example, the model 116 dynamically predicts factors associated with debit and credit trend data likely to influence the predicted future cash-flow (e.g. periodic income payments from employment credited to the one or more customer account, periodic bill payments debited from the one or more customer accounts as shown in FIG. 2).

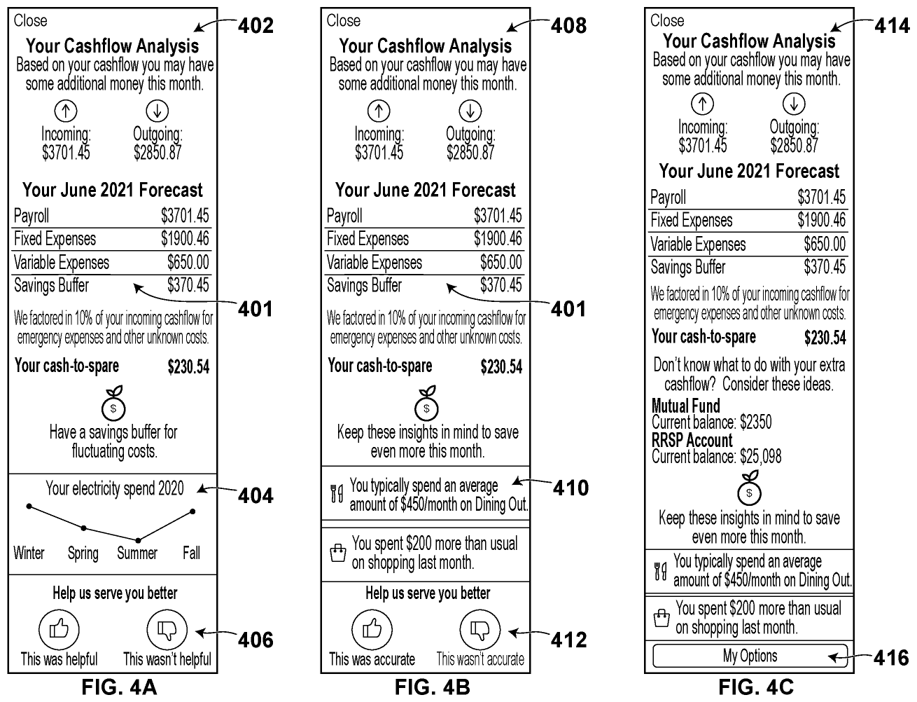

In addition to generating the predictions of data transfers, associated prediction intervals and data transfer types or attributes, the prediction engine 114 may be configured to generate, a confidence score associated with each output prediction from one or more of the machine learning models 116. Such a confidence score may be generated for example, by the machine learning models 116 along with the prediction, based on prior test datasets and the proportion of correct predictions in a whole dataset in a testing phase of the machine learning model 116. The predictions provided from the prediction engine 114, may in at least some aspects be fed to (e.g. in the form of a nudge or triggering an action for display) one or more associated client computing devices 102, to visually display such predictions on the user interface 106 of the client application 104, such as shown in FIG. 4A, displaying in a first view 402, one or more predictions in the form of interactive visual icons in a first portion 404. In at least some aspects, the confidence score may be used to determine by the action generation module of FIG. 1D as to which connected devices receive the output prediction (e.g. first output 165) and generate an associated set of actions to be performed on the specific set of connected devices of FIG. 1D in relation to the output prediction and the confidence score (e.g. second output 167) generated therefrom.

In at least some aspects, such predictions may be provided initially to an action generation module along with a confidence score for the prediction, as generated by the prediction engine 114 (se also FIG. 1D) and the action generation module may determine which associated computing devices, if any, may receive the prediction such as for visual display on the user interface and/or further action based on the confidence score exceeding a predefined threshold. In another aspect, the confidence score once processed by the actions generations module 120, may indicate that such prediction (along with any insights generated from the insight generation module 122) is provided to only a subset of client computing devices 102 across the network 108.

Referring again to FIGS. 1A and 4A, in one example, if the actions generation module 120 indicates to display the prediction provided from the prediction engine 113 based on the associated confidence score, as shown in the first view 402, the content delivery system 100 may further trigger the client computing device 102 to display on the user interface 106, one or more feedback icons along with the predictions and associated insights, such as a first feedback icon 406, a second feedback icon 412, displayed to receive user input (e.g. positive, negative or neutral feedback or impression) on whether the digital view illustrated on the user interface 106, such as providing predictions, insights and customized actions on the user interface 106 are positively interacted with or not. Such feedback input may then be fed back to the content delivery system 100, for use by the feedback detection module 124 to dynamically revise and update the operation of the relevant modules generating the user interface (e.g. in the case of predictions, the prediction engine 114; in the case of insights, the insight generation module 122; in the case of visual action icons, the action generation module 120) and associated neural network models, such as in the machine learning model 116.

Referring now to FIG. 1D, there is illustrated an example schematic view of computing components of the prediction engine 114 such as for use in the computing environment 101 illustrated in FIG. 1A, in accordance with one or more embodiments. The prediction engine 114 illustrated in FIG. 1D, may be a system of machine learning models coupled together and cooperating in a particular manner to generate multiple concurrent outputs from a set of input features. Notably, the prediction engine 114 generates a first output 165 providing a prediction and a second output 167 indicative of a confidence score or metric defining a confidence of the machine learning models in the prediction engine 114 for generating the prediction in the first output 165. Notably, the prediction output signal provides a prediction of a future value or values of a target variable or attribute or feature of interest, based on one or more input historical dataset such as features 152 provided to a first prediction model 154 to train the model and generate a trained model. The first prediction model 154, then preferably applies regression predictive modelling to generate probable predicted value(s), such as a numerical output given an input or inputs for a future time frame or a future time (e.g. providing time series forecasting based on prior historical values of an input feature to predict an output future value for the feature). Put another way, in one example, the first prediction model 154 may be configured to determine a relationship between input and output variables and specifically, unobserved values of a single output variable or attribute based on regression modelling. In other aspects, the first prediction model 154 may be configured to apply multi-output regression predicting at least two numerical outputs given at least one input.

For example, in one implementation of FIG. 1D, a training dataset may contain a dependent variable (Y) and one or more independent variables (X) as features 152 and one effect of the first prediction model 154, the second prediction model 156 and the third prediction model 158 is to be trained in a particular manner (e.g. as shown in FIG. 1D via a series of training and retraining an initial prediction model in a particular manner for different loss functions such as to generate a second and third prediction model) to estimate various quantiles (e.g. the median, the lower 5^{th} percentile, the upper 95^{th} percentile) of the dependent variable's distribution as a function of the independent variable and thereby determine a confidence prediction (e.g. via the confidence predictor model 160). As will be described herein, the confidence prediction is for use by the system (e.g. content delivery system 100 and/or environment 101) in automatically determining subsequent computerized actions to be taken based on the prediction and associated confidence signal for the prediction defining trigger conditions for the actions.

In some aspects, the first prediction model 154 uses an XGBoost algorithm (extreme gradient boosting) which is an ensemble of many individual decision trees, whereby subsequent trees are trained to correct mistakes of prior trees. The extreme gradient boosted used gradient descent on a loss functions to determine the optimal feature and threshold to use for every split.

The first prediction model 154, the second prediction model 156 and the third prediction model 158 are regression models using extreme gradient boosting (XGBoost).

In at least one aspect, the difference(s) between the first prediction model and the confidence models (e.g. the second prediction model 156 and the third prediction model 158) is at least: the objective function and the transformation function applied on the target during the training. Preferably, the first prediction model 154 utilizes a customized objective function defined as fair loss as the regression objective. The confidence models, provided by the second prediction model 156 and the third prediction model 158 utilize quantile cost function as the objective with an additional parameter τ which specifies the τₜₕ quantile of the target variable that is of interest in modeling.

### Objective Function

### First Prediction Model 154—Variable Output Prediction

In at least some instances, the first prediction model 154 may utilize squared error loss as the loss function for regression tasks for predicting real-values variable given some input variables. In some cases, such squared error loss function may be sensitive to outliers or noise. Accordingly, upon the content delivery system 100 determining a particular example output has a heavy-tailed distribution with existence of outliers, such as via the processor 123, the machine learning model of the first prediction model 154 may be reconfigured, via the model reconfiguration module 115 and/or configuration engine 117 to perform overall accurate predictions by preventing the model from being overly emphasize on outliers-when summing over Σᵢ₌₁ⁿ(ŷ−y)², the sample mean is influenced too much by a few particular large errors (ŷ−y) when the distribution is heavy-tailed.

Based on above, in some implementations, the model reconfiguration module 115 optimizes the prediction engine 114 and particularly, the first prediction model 154 with a more robust objective function applying fair loss using the following function:

$${c}^{2} ( \frac{\vert \hat{y} - y \vert}{c} - ln ( \frac{\vert \hat{y} - y \vert}{c} + 1 ) )$$

where ŷ is the model output, y is the target, for one training instance, c is a parameter that may be selected such as via the model reconfiguration module 115 to control the tradeoff between accuracy and level of sensitivity to outliers. The fair loss formula is twice differentiable which is a desirable property with gradient boosting tree as the learning algorithm for which the first and second order derivatives are used for optimization of the first prediction model 154.

In at least some aspects, conveniently, using fair loss as the objective function for the machine learning model 116, and particularly, the first prediction model 154 can avoid the quadratic growth rate as in squared error loss, thus becoming more robust to outliers.

In at least some aspects, the machine learning models 116 configure the first prediction model 154 to minimize fair loss during training with observed data following the principle of empirical risk minimization (ERM) with the XGBoost learning algorithm as the hypothesis function which maps input variables to a real-value prediction.

In experimental results, it was further noted that a comparison of fair loss against another objective function for regression task: Huber Loss, indicated that fair loss outperforms Huber loss on out of set validation set. Preferably, fair loss is then selected by the machine learning models 116 in combination with model selector 118 as the objective function for the first prediction model 154.

### Confidence Models—Second Prediction Model 156 and Third Prediction Model 158

Referring again to FIG. 1D, in at least some aspects, it may be desirable to generate a determination or indication of amount of uncertainty behind each point estimation such as to provide more information to model users, and to associated computing devices such as for reconfiguration of models and/or defining subsequent computerized actions to be taken, such as via the insight generation module122 and the action generation module 120 in a networked computing environment 101 as shown in FIG. 1A based thereon.

Referring to FIG. 1D, in one or more embodiments, the same input as the first prediction model 154 is applied (e.g. via configuration engine 117 configuring and managing one or more prediction models in the prediction engine 114) and is used to retrain the extreme gradient boosted, XGBoost prediction model of the first prediction model 154 in multiple subsequent iterations, e.g. two times as shown in the example flow of FIG. 1D, with the quantile cost function as the objective function.

Thus, as illustrated in FIG. 1D, once the first prediction model 154 is trained via training 153 phase using features 152, the configuration engine 117 then triggers retraining of the prediction model in two subsequent phases, first retraining with upper quantile 155 and also retraining the machine learning model with lower quantile 157 to provide outputs to the confidence predictor model 160.

The immediate outputs from the retraining phases as provided from a second prediction model 156 (having been retained using the upper quantile) and a third prediction model 158 (having been retrained with lower quantile) are an upper bound 161 quantile value of the attribute or feature being predicted and a lower bound 163 of the attribute or feature being predicted which together forms a range estimation (e.g. via a confidence predictor model 160 combining the upper and lower bounds provided from the second and third prediction models) to the point estimation value (e.g. first output 165 providing target variable prediction) produced from the first prediction model 154. The confidence predictor model 160, is then configured, upon receiving the upper and lower bound outputs from the retraining phases of the second and third prediction models to transform the estimated range in the upper and lower bounds to a confidence score for each transaction or data record or data transfer evaluated for the prediction, provided as a second output 167 shown as the confidence score.

The quantile cost function applied by the configuration engine 117 is defined as:

$$L = \{ \begin{matrix}τ ( y - h ( X ) ) , & if y - h ( X ) \geq 0 \\ ( τ - 1 ) ( y - h ( X ) ) , & if y - h ( X ) < 0\end{matrix}$$

where τ∈(0, 1) specifies the τₜₕ quantile of interest, y is the target variable, h(X) is the hypothesis function which uses extreme gradient boosted (XGBoost) as the learning algorithm.

The quantile cost function applied by the configuration engine 117 to the second prediction model 156 and the third prediction model 158 configure the machine learning models, via the retraining stages, to predict upper and lower bound differs depending on the quantile of interest, which is a defined parameter, as such predictions that underestimates target are penalized more when we specify τ>0.5 and predictions that overestimate the target are penalized more when τ<0.5. The former results in an upper bound on a particular attribute prediction such as at a future time point (e.g. upper bound on predicted variable expenses at a future time), prediction, whereas the latter results in lower bound.

Thus, in at least some aspects, the prediction modelling applied by the second and third prediction models 156 and 158, utilize regression predictive modeling to perform quantile regression by the configuration engine 117 applying the above quantile cost function to model the relationship between input variables and a specific quantile (e.g. upper quantile and lower quantile) of the target variable.

By applying quantile regression in the specific manner of retraining the initial first prediction model via the configuration engine 117 in the prediction engine 114 in retraining subsequent second prediction model 156 and third prediction model 158 with upper and lower quantiles to complement the point estimation conveniently allows ability for producing a range estimation to improve performance of the model.

Notably, by retraining the initial prediction model (e.g. the first prediction model 154) with τ=0.05 and τ=0.95, using the configuration engine 117 to configure the models, the output obtained is a predicted attribute or target variable range estimation that is formed by the upper and lower bound and provided to a confidence predictor model 160. The confidence predictor model 160 then processes the upper and lower bound outputs from the retrained models together with the initial prediction model output providing target variable or attribute prediction, e.g. the first output 165, to further transform the range estimation to a confidence score provided as the second output 167 as will be described herein.

### Target Variable Prediction—First Prediction Model 154

In the inference stage of the prediction engine 114, the extreme gradient boosted algorithm of the first prediction model 154 is run one time for each input data set, e.g. each digital account associated with a user. Such digital accounts may include information such as transactions amongst computerized entities, such as a transaction handler and transaction processing systems and user or client computing devices in a networked environment as shown in FIG. 1A. Such inference produces one continuous number representing the predicted target variable or attribute in a defined future time period or periods, e.g. target expenses in the upcoming month. In one example implementation, the first prediction model 154 having been trained using training 153, then in an inference stage produces a text file format, comma separated values (CSV) file as its output, with the associated amount of predicted variable expenses included for the upcoming month.

In some implementations, the configuration engine 117 which may be responsible for controlling, configuring and managing operations of one or more machine learning models is configured, after scoring inference instances to wait until the end of a prediction window, e.g. the last day of next month after the inference date, to determine the ground truth. The configuration engine 117 may determine ground truth labels in the same way as during training.

### Confidence Models-Prediction Engine 114

In inference, the configuration engine 117 may cause the extreme gradient boosted algorithm to run two times (e.g. via the second prediction model 156 and the third prediction model 158) for each input data set having features 152, e.g. account. This produces two continuous output numbers ŷᵤₚₚₑᵣ, ŷ_{lower} representing the upper bound 161 and lower bound 163 of the variable target prediction for a particular feature or attribute y produced from the first prediction model 154.

In one aspect, the prediction models in the prediction engine 114 including the first prediction model 154 the second prediction model 156 and the third prediction model 158 produce a special digital textual file format output such as CSV file as its output, with the upper bound 161 and lower bound 163 included and a confidence score S_{c} formed at the confidence predictor model 160 from the upper and lower bounds, and provided as a second output 167.

$${S}_{c} = \frac{\hat{y}}{\vert {\hat{y}}_{upper} - {\hat{y}}_{lower} \vert}$$

where ŷ is the output from the first prediction model 154 and ŷᵤₚₚₑᵣ and ŷ_{lower} are the outputs of the confidence model(s), e.g. the second prediction model 156 and the third prediction model 158 applied to the confidence predictor model 160.

### Target Transformation

In regression tasks with machine learning, it is desirable to normalize or transform the target variable for various reasons including training stability and robustness. Thus, if the configuration engine 117 determines that in the variable target prediction task, the distribution of the target is skewed and heavy-tailed which would result in poor performance and optimization being dominated by outliers or instances on the tail of target distribution, then the configuration engine 117 is configured to apply a non-linear transformation function such as a log transform on the target value when training the prediction models, e.g. the first prediction model 154.

### Confidence Model(s) Implementation

In implementing the second and third prediction models 156 and 158, the extreme gradient boosted model is modified, via the configuration engine 117, such that it supports a customized objective function as described herein. Notably, the configuration engine 117 is configured to determine and provide the gradient and hessian (first-order derivative and second-order derivative) of the customized objective function to the corresponding interface in the machine learning library defined in the configuration engine.

Thus, in at least some implementations, the configuration engine 117 is configured to calculate the gradient and hessian function of the quantile objective function and implement them with the interface provided by the machine learning library.

### Objective Function(s)

As described earlier, the quantile objective function, which may be applied by the configuration engine 117 to the second prediction model 156 and third prediction model 158 is defined as:

$$L = \{ \begin{matrix}τ ( y - h ( X ) ) , & if y - h ( X ) \geq 0 \\ ( τ - 1 ) ( y - h ( X ) ) , & if y - h ( X ) < 0\end{matrix}$$

where τ∈(0, 1) specifies the τₜₕ quantile of interest, y is the target variable, h(X) is our hypothesis function which uses extreme gradient boost (XGBoost) as the learning algorithm.

In one aspect, the configuration engine 117 can derive the gradient and hessian of above quantile objective function such that the direct form of the gradient would be:

$$\frac{\partial L}{\partial h ( X )} = G = \{ \begin{matrix}1 - τ , & if y - h ( X ) < 0 \\ - τ , & if y - h ( X ) \geq 0\end{matrix}$$

However, in some examples, the direct form of gradient would introduce singularity which may further lead to instability during training. Therefore, preferably, the configuration engine 117 further introduces a form of smoothing on the gradient as below and provides a desirable approximation.

$$G = \{ \begin{matrix}1 - τ , & if y - h ( X ) < ( τ - 1 ) δ \\ - \frac{( y - h ( X ) )}{δ} , & if ( τ - 1 ) δ \leq y - h ( X ) < τ δ \\ - τ , & if y - h ( X ) \geq τ δ\end{matrix}$$

where τ∈(0, 1) specifies the τₜₕ quantile of interest, y is the target variable, h(X) is our quantile model prediction. δ=100 is the chosen smoothing factor.

Preferably, the configuration engine 117 may configure one or more machine learning models of the prediction engine 114 and sets the smoothing factor as 100 because when the error is within the smoothed region (τ−1)δ≤y−h(X)<τδ, less gradient will be assigned compared to the region y−h(X)≥τδ.

During extreme gradient boosted (XGBoost) optimization, which is performed by the configuration engine 117, less gradient means less correction on the weights. Taking the upper bound prediction as an example, setting the smoothing factor as 100 via the configuration engine 117 may be defined in some aspects because when the upper prediction is within a defined small amount as compared to the ground truth, thus accurate enough and no further need for the configuration engine 117 to enforce correction further to prevent over-fitting.

The Hessian on the above gradient function may be calculated via the configuration engine 117 as follows:

$$H = \{ \begin{matrix}\frac{1}{δ} , & if ( τ - 1 ) δ \leq y - h ( X ) < τ δ \\ 0 , & otherwise\end{matrix}$$

In some additional example aspects, the quantile loss function may be defined as below:

$$L = \{ \begin{matrix}( τ - 1 ) ( y - h ( X ) ) , & if y - h ( X ) < ( τ - 1 ) δ \\ - \frac{h ( X ) ( 2 y - h ( X ) )}{2 δ} , & if ( τ - 1 ) δ \leq y - h ( X ) < τ δ \\ τ ( y - h ( X ) ) , & if y - h ( X ) \geq τ δ\end{matrix}$$

Referring at a high level to FIG. 1D, the second and third prediction models 156 and 158 provide additional metadata for the prediction, e.g. the target variable prediction provided by the first output 165 by determining a degree of confidence for each prediction in a unique implementation. That is, as shown in FIG. 1D, this is achieved by the configuration engine 117 triggering the retraining of the existing model (e.g. first prediction model 154) in to generate the second prediction model 156 and the third prediction model 158. In one implementation, the configuration engine 117 upon detecting the generation of the first prediction model 154, generates the second and third prediction models 156 and 158 via retraining the existing model.

Notably, the configuration engine 117 may be configured to increase a hyper-parameter in the loss function of the third prediction model 158 to penalize more on overestimation for generating the lower bound 163 and to decrease the same hyper-parameter to penalize more on underestimating for the second prediction model 156 to generate the upper bound 161.

Thus, put another way, the quantile loss function may be defined as:

$$L = \{ \begin{matrix}τ ( y - h ( X ) ) , & if y - h ( X ) \geq 0 \\ ( τ - 1 ) ( y - h ( X ) ) , & if y - h ( X ) < 0\end{matrix}$$

where τ∈(0, 1) specifies the τₜₕ quantile of interest, y is the target variable, h(X) is the hypothesis function which uses extreme gradient boosting (XGBoost) as the learning algorithm (e.g. mapping input variables to a real value prediction).

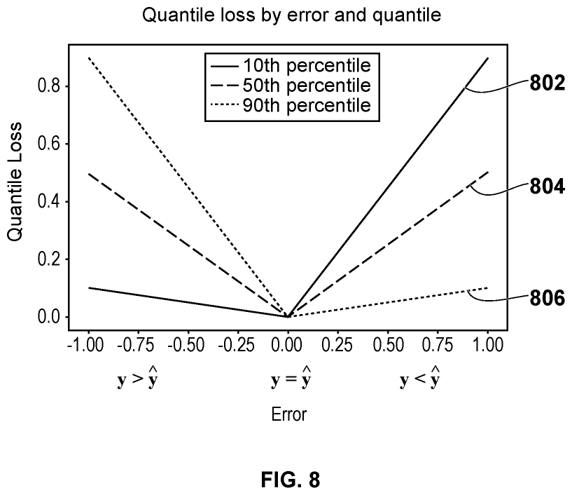

Put another way, the configuration engine 117 is configured to penalize the prediction models (e.g. the second prediction model 156 and the third prediction model 158) more when overestimating for the lower bound (e.g. τ=0.10 for predicting 10^{th} percentile as the lower bound) as shown as first line 802 in the graph of quantile loss by error and quantile of FIG. 8. The configuration engine 117 is further configured to penalize equally on overestimate and underestimate using the existing prediction model (e.g. the first prediction model 154) applying squared error loss such as L=(y−xθ)² whereby the loss is a measure of how well the model's predictions match the actual values.

In the context of squared error, the above loss function is the square of the difference between the predicted (xθ) and ground truth or actual (y) values. The variable y is the actual or observed value for a given data point; the variable x represents the feature vector for a particular data point. Put another way, x is a vector containing the input features, and θ is the parameter vector (also known as weights) that the model learns during training. The variable θ is the parameter vector or weight vector that the model adjusts during the training process to minimize the squared error. One goal during training of the linear regression model, as may be implemented in the first prediction model 154, is to find the values of θ that minimize the overall squared error across the entire dataset. Minimizing the squared error for the first prediction model 154 may be done via the configuration engine 117 applying optimization techniques such as gradient descent, where the model iteratively adjusts the weights θ in the direction that reduces the squared error. An example of such 50^{th} quantile percentile is shown at a second line 804 of FIG. 8 depicting quantile loss by error and quantile. An example of upper bound prediction, e.g. 90^{th} percentile is shown at a third line 806, whereby at least one of the prediction models of the prediction engine 114, e.g. the second prediction model 156, predicting the upper bound (e.g. τ=0.90 in the example illustrated for predicting the 90^{th} percentile).

As described earlier and referring again to FIG. 1D, once the upper bound, lower bound and predicted value (e.g. mean) of a target variable are generated via the models of the prediction engine 114, then the confidence predictor model 160 is configured to utilize the input data to generate an output signal indicative of the confidence score, whereby:

$$Confidence = \frac{\hat{y}}{\vert uppe r bound - lower bound \vert}$$

Referring back to FIGS. 1A and 1D, one or more outputs from the prediction engine 114, such as the output predictions and/or the confidence score provided by a first output 165 and a second output 167, may then be fed into an insight generation module 122 and/or an action generation module 120, such as to trigger subsequent computerized actions for one or more computing devices of the environment 101, such as for further determining a computerized action to be performed on one or more associated computing devices, such as client computing devices 102 including user interface 106 of client applications 104 or controlling transactions between computing devices in the environment 101 such as between the data processing server 110, the client computing devices 102 and the content delivery system 100 across the network 108 of FIG. 1A.

In some aspects, the action generation module 120 of FIGS. 1A and 1D may determine from the confidence score of the prediction being “low” (e.g. detected by the module as being below a defined threshold stored in the confidence score repository 128) then the associated computerized action of preventing generating the output prediction and associated insight (e.g. from the insight generation module 122) onto one or more associated computing devices or alternatively, upon detecting such a low prediction score, the action generation module 120 may trigger the configuration engine 117 to retrain and regenerate the prediction models with applying the prior iteration outputs of the predictions models including the confidence score, e.g. second output 167 and the associated prediction, e.g. first output 165, back to the configuration engine 117 for generating an improved prediction model having a higher prediction score as determined via upper and lower bound quantile predictions from the second and third prediction models 156 and 158 and the confidence predictor model 160 for subsequent iterations of configuring and generating the first prediction model 154 to account for a prior iteration of the model having a below desired prediction score. In other aspects, detecting, via the action generation module 120 that the confidence score output is below a defined threshold, as retrieved from the confidence score repository, may trigger, the content delivery system 100 (e.g. the model reconfiguration module 115) to gather additional data related to the variable to be predicted including new data received since the prior training phase as retrieved from the environment 101 of FIG. 1A, such as from the data processing server 110 and/or client computing devices 102 for subsequent re-training of the models of the prediction engine 114. Thus, detecting a low confidence score, via the action generation module 120 may cause the configuration engine 117 to apply data augmentation techniques to one or more of the prediction models of the prediction engine 114 to generate additional training examples that are similar to the uncertain instances and cause the models (e.g. the first prediction model 154, the second prediction model 156, and the third prediction model 158) to be retrained to learn from the variations and improve its performance.

In other aspects, upon detecting a low confidence score output from the confidence predictor model 160 as compared to an expected score from the confidence score repository 128, the action generation module 120 may trigger one or more signals to cause a retraining process or update the hyper parameters of the models in the prediction engine 114 via the configuration engine 117, and particularly starting with the first prediction model 154 based on the uncertain predictions from the first output 165, incorporating the new information to improve the performance of the prediction engine 114 over time.

In other example aspects and referring to FIGS. 1A and 1D, the action generation module 120, upon detecting a “high” confidence score from the second output 167 (e.g. confidence score as calculated specifically from the upper and lower bound quantile predictions via the confidence predictor model 160 being higher than a defined threshold), may be configured to control operations and communications with one or more connected computing devices across the network 108 in the environment 101. For example, this may include triggering the insight generation module 122 to generate digital content and associated digital resources for display on one or more client computing devices 102 and client applications 104 requesting the prediction, such as via the user interface 106 along with one or more graphical user interface control options triggered for display on the user interface 106 for performing one or more defined computerized actions on the device or in combination with associated devices (e.g. transfer of data between a source device and a destination device) based on the confidence score prediction.

In other example aspects and referring to FIGS. 1A and 1D, upon the action generation module 120 detecting a “high” confidence score from the confidence predictor model 160 based on the upper and lower bound quantiles (e.g. by comparing the second output 167 to an expected confidence score retrieved from the confidence score repository 128), then the action generation module 120 may trigger the configuration engine 117 to optimize performance of the first prediction model 154 based on the high confidence predictions such as adjusting the hyper parameters of the model to further improve accuracy or efficiency of the model; or reinforce the model's subsequent training by provide accurate instances for positive reinforcement, thereby contributing to continuous learning and improvement of the first prediction model 154.

As noted earlier, the action generation module 120 may access a confidence score repository 128 containing a mapping between a range of potential confidence scores generated by the prediction engine 114 and associated computerized actions to be taken by the content delivery system 100 or triggered by the content delivery system 100 for performing on associated computing devices in the environment 101. Such actions may include in at least some aspects, causing the client computing device 102 which is delivered content for display on the user interface of one or more client applications 104 provided from the content delivery system 100 related to the prediction output generated from the first prediction model 154, to further connect to associated computing devices (e.g. data processing server 110 or other computing devices) to perform actions as pushed or triggered via the content delivery system 100 based on a determination from the action generation module 120 of the associated action to be performed on the client computing device 102 based on the confidence score level. An example of such triggering of the client computing device 102 to connect to external devices for performing a defined action as required by the content delivery system 100 is illustrated in the process of FIG. 2.

In other aspects, and referring to FIG. 1D, upon the action generation module 120 receiving an output of the confidence score, it may trigger the prediction engine 114 to provide the output prediction, e.g. first output 165 along with the generated confidence interval and/or confidence score from the second output 167 via the insight generation module 122 concurrently to the client computing device 102 to communicate a degree of uncertainty associated with the prediction such that subsequent actions performed by the client computing device 102 and/or data processing server 110, are configured to account for such degree of uncertainty.

In some aspects, triggering such communication is further initiated in response to positive graphical user interface input feedback received on the user interface 106 in response to displaying the predictions (e.g. selecting the first feedback icon 406). Notably, the insight generation module 122 may further implement one or more machine learning models, including supervised learning models such as extreme gradient boosted models to generate, based on the predictions provided from the prediction engine 114 (e.g. predicted future data transfers, and data transfer attributes), a set of personalized digital insight content, in the form of visual insight icons containing the content to be presented on the user interface 106 of the client application 104. Upon generating the digital insights, the insight generation module 122 may then trigger the client computing device 102 to display same on the user interface 106 such as via one or more client applications 104. Such digital insights may be generated to reinforce digital transactions or data transfer patterns in the networked environment of FIG. 1A such as across the network 108 and between the computing devices, e.g. content delivery system 100, client computing device 102, and data processing server 110.

Referring to FIG. 4B, there is shown a second example view 408 of the user interface 106 for the client application 104, illustrating sample insights, such as a first set of digital insights 410. In general, the digital insights generated may indicate that the content delivery system 100 has accurately analyzed the digital behaviours of the one or more client computing devices 102 within a networked environment, such as that of FIG. 1A, including performing data transfers across the network. The digital insights may for example display digital analytical content based on capturing, and analyzing the data transfer patterns and predicting future trends and behaviours of the data transfers from the prediction engine 114. The digital insights provided by the insight generation module 122, may in some aspects, provide digital data and content to define how the predictions generated by the prediction engine 114 were generated and insights to indicate analytics on how other similar digital users improved similar data transfer predictions. The third example view 414 of FIG. 4C further illustrates additional view when one or more of the objects providing an initial set of insights and/or predicted output data transfer values are interacted with, such as to display a set of action icons (e.g. a first action icon 416) on the user interface 106 as shown in FIG. 4C, which may be generated via the action generation module 120.

Thus, one aspect of the embodiment of the insight generation module 122 includes triggering a presentation, e.g. on one or more client computing devices 102, of predicted future data transfer patterns (e.g. see forecasted first portion 401) and insights including one or more features associated with the historically influenced data transfer (e.g. cash flow patterns) as derived from the prediction engine 114 and the machine learning model 116 as well as factors likely to influence predicted future data transfer trends. Such digital insights based on past data transfers and future predictions may be presented, such as the first set of digital insights 410 displayed alongside the forecasted patterns of data transfers and associated attributes (e.g. see forecasted first portion 401) and the second feedback icon 412. Although the screen views 4A-4C illustrate digital insights related to financial transactions and attributes (e.g. variable, fixed, incoming, outgoing, etc.), as described herein, other data transfer types may be envisaged as described herein and triggered/presented for display on the user interfaces of associated computing devices.

Although FIG. 1A illustrates a single client computing device 102, a single data processing server 110 and a single content delivery system 100, in some embodiments the networked computing environment can include multiple different user client computing devices 102, each associated with a different end user for associated client applications 104 and user interfaces 106, and the networked computing environment may also include additional data processing servers 110 and content delivery system 100 for handling data transfers and generating digital user interface content including digital insight objects and digital action icons for different groups of end users or client computing devices 102.

In one aspect, the insight generation module 122 may perform additional tracking and monitoring transaction behaviour of all computing devices (e.g. within the networked environment of FIG. 1A) such as to create a profile history repository 132 for all computing devices 102 storing a history of prior data transfer patterns and corresponding insights interacted with (e.g. having a positive feedback). Thus, the content delivery system 100 may store, via a customer profiling module 126, within the profile history repository 132, a set of profiles of end users (and associated one or more client computing devices 102) in the networked environment of FIG. 1A and associated data transfer patterns and digital behaviours. The information stored in the customer profiling module 126 may include user characteristics such as the user names, user identification, prior user interactions with client applications 104 and graphical user interfaces 106 including feedback received thereon in response to prior presented digital insight content and historical data transfer patterns (e.g. data transfers within each of the attribute types over a past time period), user preferences, and information relating to any previous user interactions via the client computing device 102 and/or the client applications 104 within the networked computing environment of FIG. 1A (e.g., requested data, provided data, data transfers performed in relation to one or more accounts held on the client applications 104, associated users and computing devices, etc.).

Thus, the customer profiling module 126 may access, in response a digital insight being generated by the insight generation module 122, the profile history repository 132 and determine a new device or user profile for which an insight is being generated should be grouped with other similar profiles (e.g. based on variability of data transfers and similarity of digital behaviours). The insight generation module 122 may then be configured to further customize the insights generated form the predictions of the prediction engine 114, responsive to a determination from the customer profiling module 126 that a given data transfer associated with a particular device and digital users is similar in profile to other device/user profiles and thereby generate digital insights accordingly. Thus, in one aspect, the insight generation module 122, may apply data transfer patterns extracted by way of the trained machine learning model 116, for the associated computing devices and use the customers grouped as similar to those under consideration to generate the digital insights, by way of the machine learning modules in the insight generation module 122. For example, such insights generated by the insight generation module 122 may provide analytical content (text, images, audio, and/or videos) on the user interface 106 that other device profiles (e.g. user) similar to the client of the client application 104 found such particular set of insights helpful (e.g. based on monitoring feedback from computing devices 102 by way of the feedback detection module 124) and thereby trigger the customized graphical user interface 106 displaying same. By way of example, user interfaces of computer devices on which the digital content providing the digital insights may be presented are shown in FIGS. 2, 3, 4A-4C, and 5A-5B.

In at least some aspects, the insight generation module 122 may further be configured to tailor the generated digital insights from one or more predictive machine learning models, which are initially generated based on the predicted data transfers and the user profiling of similar users having an associated set of successfully interacted with digital insights further based on a set of confidence scores. Notably, in one or more implementations, the prediction engine 114 may generate a set of confidence scores for the prediction generated therefrom indicative of the prediction engine 114 confidence level of the prediction and possible associated computerized actions, e.g. predicted future data transfer. Such confidence scores may be stored within a database such as a confidence score repository 128. In one example aspect, such confidence scores may then be used by the insight generation module 122 to determine subsequent computerized actions to be taken by one or more computing devices of the environment 101, such as modifying the tone, the language and textual mapping of the visual insight based on same. In one aspect, the insight generation module 122, may access a content template repository 130 storing a mapping of textual content and/or portions of text and/or language along with associated confidence scores to be applied based on the confidence score. Thus, the insight generation module 122, may thus apply the confidence scores for predicted future data transfer predictions generated by the prediction engine 114 to determine the language/content of the insights retrieved.

In one or more embodiments, as illustrated in FIG. 1D, the action generation module 120 may cooperate with the prediction engine 114 to determine subsequent computerized actions performed specifically in response to the confidence score and/or the prediction output. For example, a low confidence score (e.g. a comparison of the confidence score to a predefined required confidence score may be performed on the action generation module 120) as generated by the machine learning models for a given prediction output as determined by the prediction engine 114 may cause the content delivery system 100 to prevent or cease providing the prediction output and related content to one or more client computing devices 102, such as for display on the user interface 106. In one aspect, such actions triggered by the generation of the prediction output, first output 165, as generated may be determined via accessing a database of a set of defined computerized actions mapped onto confidence score ranges output by the prediction engine 114.

Preferably, the insight generation module 122 generates the digital insights based on the metrics in the predicted data transfer provided by the prediction engine 114, and customized based on a determination of similar profiles for the data transfer and associated retrieved content previously determined as efficient for other similar profiles

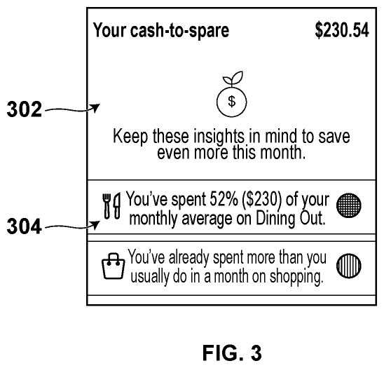

Referring to FIG. 3, shown is an example insight screen portion 302 of the user interface 106 indicating predicted future performance metrics for the data transfer, and an associated set of digital insights 304, generated by the neural network framework of the content delivery system 100.

In at least some aspects, the content delivery system 100, may be configured, via the insight generation module 122 to dynamically manage the contextual digital insights related to the data transfer predictions presented to the user interface 106 of the computing device 102 such that the presentation of the digital insight objects presented on the user interface screen (e.g. text, images, and/or video content) is dynamically adjusted based on the relative confidence score of the one or more factors and/or attributes used to derive the predicted output of the machine learning model 116 (as also output from the model 116).

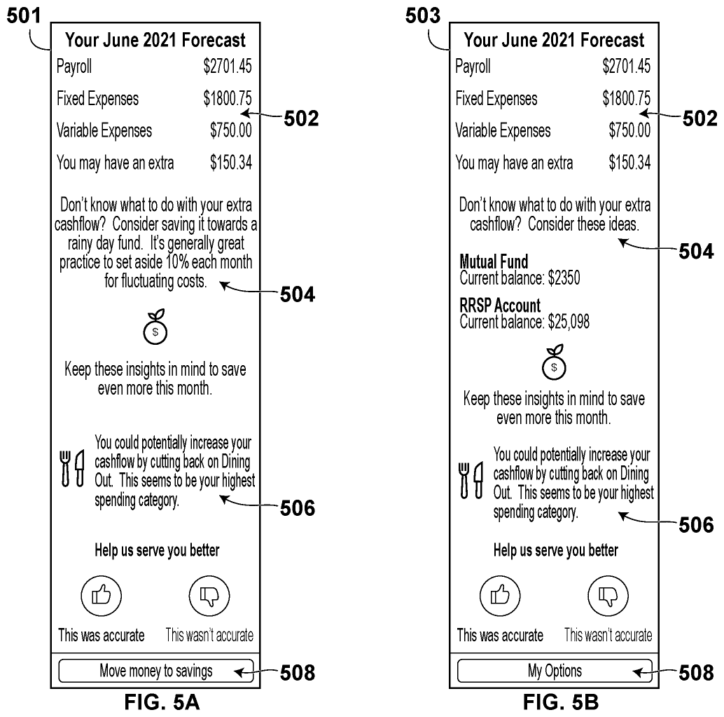

FIGS. 4B and 4C show example user interface screens of the computing device 102 whereby the objects presented on the user interface relating to digital insight content generated from the content delivery system 100 are dynamically managed such that different formats and content of digital insight objects are presented on the user interface screens based on a relative contribution score of different predicted outputs. In one example embodiment, where the prediction engine 114 generates a plurality of predictions for data transfers having different attributes (e.g. fixed, variable, etc.) then a different confidence score may be associated with each of the generated attributes and thus the insight generation module 122 may generate the digital insight objects based on accessing templates associated with a composite or average score of confidence for the attributes (e.g. as retrieved from the content template repository 130) to tailor the output digital insight objects and formatting displayed to the client computing devices 102. Similarly, FIGS. 5A and 5B illustrate two different example user interface screens 501 and 503 illustrating, in a first screen portion 502, the forecasted or predicted data transfer outputs for various different attribute categories, as generated by the trained machine learning model 116 whereby each category is generated via a different machine learning model selected by the model selector 118. In a second screen portion 504, a plurality of objects containing insight digital content (e.g. text, image, video) are presented having different formats and/or language and/or template of the content. As described herein, the digital insight format and content may be tailored as selected by the insight generation module 122, based on an aggregate or average of the confidence score generated by the prediction engine 114 of FIG. 1A, for each of the predicted categories of data transfer and determining based on continually monitoring feedback of the client computing devices 102, prior digital insight objects that were successfully engaged with in prior iterations of the content delivery system 100 and using same for delivering content that was previously successful for other similar parties (e.g. source and destination devices) involved in the data transfer, as determined by the customer profiling module 126. Examples of different digital insight content 506 is illustrated in FIGS. 5A and 5B. Additionally, the user interface screens 501 and 503 illustrate different action icons 508 generated by the action generation module 120 based on the insights provided by the insight generation module 122 and thereby extracting a set of associated actions (e.g. from the content template repository 130) previously determined to improve one or more of the predicted data transfer types generated by the prediction engine 114.

Referring again to FIG. 1A, in some aspects, when one or more digital insight objects (e.g. text, audio, video, image content) presented on the user interfaces 106 of the client application 104 are interacted with or otherwise “selected” such as by clicking the icon, then such feedback may be detected via the feedback detection module 124 and trigger the generation of one or more action icons on the user interface 106 to perform computerized actions related to the data transfer and preferably, to improve the predicted performance metrics of the output of the prediction engine 114 and to perform at least one related subsequent data transfer action within the networked computing environment of FIG. 1B. A click or selection of the digital insight icons or associated icons may refer to a user selection or an automatic selection of a particular item of digital insight content. Such feedback may include any digital impressions received in response to presenting the one or more digital insights on the interactive user screens of the client applications 104. In one example, referring to FIG. 2, a first screen 252 illustrates digital insights and/or forecasted future data transfer metrics as textual and/or image content on the screen which may be further interacted with, via selection of an information icon 263 to trigger generation, via the feedback detection module 124, of additional action icons (e.g. 260, 264 and 268) shown in the second screen 254 and the third screen 256 of the graphical user interface 106. In another example, referring to FIG. 4A, when the first feedback icon 406 is interacted with then a subsequent more detailed screen as shown in FIG. 4B may illustrate an additional set of insights as generated by the insight generation module 122, and when the one or more interactive insight object icons on the screen of FIG. 4B are interacted with then one or more action icons, such as a first action icon 416 providing an option to select and perform one or more computerized action via the third example view 414 in FIG. 4C may be displayed.

Referring again to FIG. 1A, the content delivery system 100 may thus further include the feedback detection module 124, the feedback detection module 124 may cooperate with an insight generation module 122 and an action generation module 120 to adjust the one or more visual objects containing insights by displaying objects for triggering computerized actions on the user interface 106. An aspect of the disclosure for the content delivery system 100 may further comprise tracking feedback received from input on the client computing device 102 client application 104 in response to the insight which includes determining whether a positive or a negative response (e.g. indicating a presented insight as helpful or not such as via first and second feedback icons 406 and 412) was received on the user interface 106.

In one or more aspects, the action generation module 120 may further dynamically determine one or more subsequent actions to improve the predicted future data transfer metrics associated with one or more data records for the client application 104, and present the computerized actions as selectable icons to the user interface of the client computing device 102 (e.g. as shown in the example user interface in FIG. 2, FIGS. 4C and 5B).

Referring to FIG. 2, there is illustrated a schematic diagram showing an example flow of operations and a corresponding series of interface screens, shown as a first screen 252, a second screen 254, and a third screen 256 illustrating different instances and example views of the user interface 106 for the client application 104, in accordance with one example embodiment. Initially, at a first step 1, the content delivery system 100 triggers the display of the first screen 252 via a targeted and personalized digital nudge (e.g. a push notification provided from the content delivery system 100 to the client computing device 102 across the communications network 108) providing digital content including predicted future data transfer content 261 and in some aspects, an initial digital insight related to the predicted future data transfer values, which when selected triggers the additional display of a set of feedback icons at a second step 2, shown as a menu of feedback options 262. At step 3, the feedback input received on the user interface screen is acknowledged and fed back from the client computing device 102 to the feedback detection module 124 for generating digital insight content via insight generation module 122. At step 4, an additional interface screen may be presented in response to the prior feedback allowing navigation of an end to end experience, including presenting one or more selectable initial action icons 260, as provided by the action generation module 120 along with forecasted future data transfer values for various categories at step 5. The action icons, provide proactive guided steps for the user interface to improve one or more of the forecasted objects displayed and perform associated computerized operation. At step 6, the set of objects displayed may be dynamically updated as additional feedback is received for the content delivery system 100. At step 7, by selecting the action icons 260, additional action icons 264 may be displayed as triggered via the feedback detection module 124 in cooperation with the action generation module 120 providing further actions and such selection triggering, at step 7, connection of the client computing device 102 via the client application 104 to one or more other computing devices and digital platforms (e.g. digital applications such as social networking or communication applications). This may trigger the display of additional display screens 258 illustrating connection of the client application to navigate automatically to one or more other digital platforms (e.g. a messaging application for performing messaging related to the data transfer insight detected) for performing subsequent actions as triggered by the content delivery system 100 in response to the navigation of prior action icons.

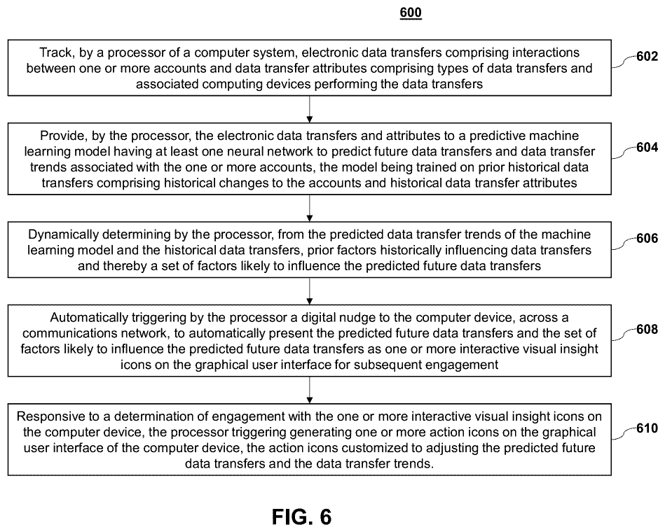

Referring to FIG. 6 shown is an example flow of operations 600 illustrating a method for the content delivery system 100 of FIG. 1A implementing the prediction engine 114 for generating dynamic digital content relating to data transfer predictions and triggering generation of a customized user interface containing the digital content proactively in a networked client computing device 102. In at least some aspects, a non-transitory computer readable medium stored on the content delivery system 100 can comprise instructions, that when executed by one or more processors 123, cause a computing device to perform the operations of FIG. 6. The content delivery system 100 may comprise a processor configured to communicate with one or more client computing devices 102 across a networked environment to generate digital content and objects to provide a graphical user interface 106 thereon.

At operation 602, operations comprise tracking by a processor 123 of a computer system such as the content delivery system 100, electronic data transfers (e.g. data transactions including but not limited to: communication transactions, social media transactions, data security transactions, other computerized transactions involving a source and destination device and associated data transfers, etc. in a network computing environment such as that shown in FIG. 1A). The electronic data transfers may comprise interactions between one or more data records (e.g. accounts held on various client computing devices 102 for client applications 104) and data transfer attributes comprising types of data transfers (e.g. variable, fixed, incoming, outgoing, data security, etc.) and associated computing devices (e.g. one or more networked client computing devices 102) performing the data transfers. In at least some aspects, the tracking of the data transfers and the collected data may be done as a collaboration and cooperation between the content delivery system 100 and one or more data processing servers 110, storing at least some of the data transfer data and associated user and device profiles within one or more data records on the database systems 112.

Following operation 602, upon receiving the data transfer information, operation 604 comprises providing by the processor 123 of the content delivery system 100, the electronic data transfers and attributes to a predictive engine 114 having one or more machine learning models 116 (e.g. at least one neural network) to predict future data transfers over a future time interval and associated with the one or more accounts or data records for the data transfers. The one or more machine learning models 116 are specifically trained, e.g. using supervised machine learning, on prior historical data transfers comprising historical changes to the accounts and historical data transfer attributes. Preferably, the machine learning models 116 are each specifically selected to address and predict a particular type of data transfer and utilize regression predictive modelling such as extreme gradient boosted models for each of the attribute types.

Following operation 604 at operation 606, the processor 123 is configured to dynamically determine, from the output of the prediction engine 114 including predicted data transfer trends from the machine learning model(s) 116 and the historical data transfers (e.g. as obtained from the data processing server 110 and/or tracked via monitoring operations of the client computing devices 102), prior factors historically influencing data transfers and thereby a set of factors likely to influence the predicted future data transfers, the factors being associated with particular types of data transfers. Such factors may be extracted from the machine learning model 116 once trained and tested to predict data transfers and associated time intervals in a future time period.

Following operation 606, at operation 608, the processor 123 is configured to automatically trigger a computer signal across a communications network 108 (e.g. a push signal or a digital nudge) to the client computing device 102 to trigger automatically presenting the predicted future data transfers and the set of factors likely to influence the predicted future data transfers as one or more interactive visual insight icons on the graphical user interface 106 for subsequent engagement (e.g. see also FIGS. 2, 3, 4A, 5A and 5B illustrating example operation of an initial digital nudge and associated graphical user interface displays generated).

Following operation 608, at operation 610, the processor 123 is configured, responsive to a determination of engagement with the one or more interactive visual insight icons on the client application(s) 104 of the client computing device 102, to trigger generating one or more action icons (e.g. see example action icons and corresponding digital content in FIGS. 2, 4C, 5A and 5B) on the graphical user interface 106 of the client computer device 102. In at least some aspects, the one or more action icons (e.g. for performing digital actions in response to their selection) are generated dynamically by the content delivery system 100 based on tracking network activity relating to data transfers and prior interactions with the client applications 104 (e.g. including positive, neutral and negative digital feedback received thereon) and customized to adjusting the predicted future data transfers and the data transfer trends, e.g. such as to improve performance metrics for one or more data transfer attributes. As described earlier, the content delivery system 100 may utilize the insight generation module 122 in collaboration with the feedback detection module 124, the customer profiling module 126, and the action generation module 120 to automatically generate and modify digital content related to data transfer predictions and associated digital actions in accordance with the operations of one or more client computing devices 102 operating in a networked computing environment.

In at least some aspects, the generation of digital action icons (e.g. providing proactive digital guidance of navigating the client application 104) may also include the content delivery system 100, via the action generation module 120 automatically causing the associated client computing device 102 for which the digital content is being generated, to automatically connect from the client application 104 to one or more other digital platforms and associated software applications (e.g. social media platforms, media sharing platforms, service oriented platforms, digital communication platforms). An example of this is illustrated in the flow of operations of FIG. 2, wherein at step 7, the content delivery system 100 causes, in response to detecting feedback on the insight icons and/or action icons presented on one or more screens (e.g. second screen 254 and third screen 256), to automatically connect to additional digital platforms (e.g. such digital platforms may be stored on the current client computing device 102 and/or accessed via other computing devices of the networked computing environment of FIG. 1A). The digital platform may refer to software and/or hardware based online infrastructure and applications which facilitate transactions and communications between client computing devices 102 and/or computing devices of the networked environment of FIG. 1A. Such digital platform connection triggered by the content delivery system 100, as per the methods described herein conveniently provides an enhanced digital user interface with enhanced digital content and connectivity operation to proactively and automatically connect to relevant digital platforms and applications based on extracted and predicted digital insights provided by the neural network framework of the content delivery system 100.

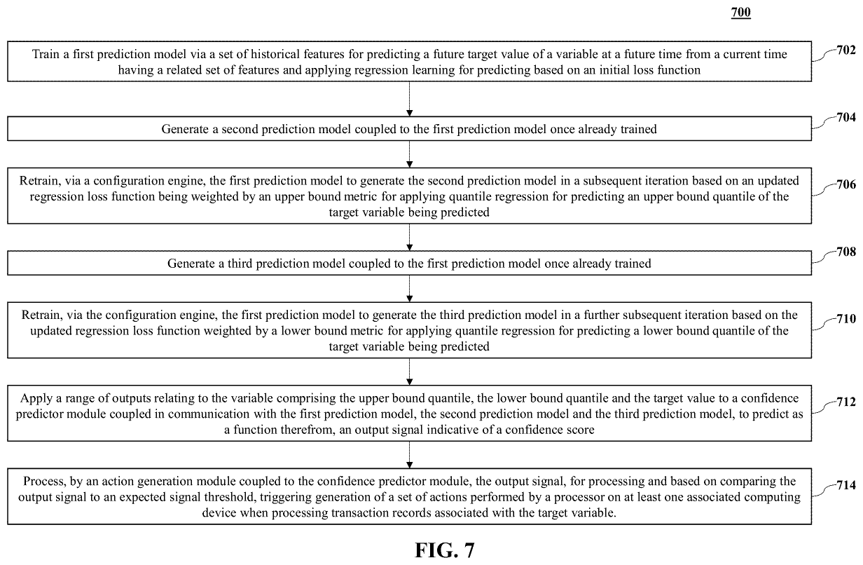

Reference is now made to FIG. 7, which shows, in flowchart form, one example method 500 for providing a system of predictive machine learning models, and more specifically providing a system of regression based machine learning models particularly configured and trained for providing predictive insights and computerized actions. The method 500 may be implemented by way of computer-executable software instructions stored on a readable medium that, when executed, cause one or more processors and/or other computing elements to carry out the operations described. In one example, the software instructions are executable from within a server computer system, such as the example content delivery system 100 (FIG. 1A) described above.

In operation 702 and also with reference to FIGS. 1A and 1D, the content delivery system 100 receives at a prediction engine 114, a set of input features and associated data used for training a first prediction model 154. Such features may be retrieved across the network along with associated training data observed, such as from the environment 101 and communication of the content delivery system 100 transactions across the network 108, with the data processing server 110, and the client computing device 102. The client device may be an end user device or an enterprise user interface device.

In operation 702, such training of the first prediction model 154 may include using a set of historical features and associated known or labelled values for predicting a future target value of a variable or attribute of interest at a future time from a current time having a related set of features to the historical features (e.g. the historical features may include the variable of interest and associated values as well other transaction related variables and values based on transactions communicated in the environment 101) and applying regression learning for predicting the future or target value of the variable of interest. In one example financial transaction based application whereby digital transactions are communicated between the computing devices of the environment 101, the first prediction model 154 may be configured to predict future income or expenses based training on a set of historical features, including but not limited to: income in historical months, digital transaction behaviors for transactions communicated (e.g. max and minimum values of transaction and frequency of transactions related to the future variable of interest) and customer profiles for end users associated with the client computing devices including status of accounts held and subcategory of types of transactions initiated. Although a specific financial application may be described herein as an example prediction (e.g. predicting income or expenses), such is presented as an exemplary embodiment and other non-financial applications of predicting various computer-related variables or features in the environment 101 may be envisaged such as predicting features or attributes including but not limited to: system performance metrics (e.g. prediction of system resource utilization, response times, or other performance indicators); network data and traffic pattern predictions (e.g. forecasting patterns in network traffic, identifying potential bottlenecks or anomalies); transaction patterns in computing applications (e.g. predicting interaction with software applications of the environment 101); predicting digital security issues; predicting resource utilization in cloud computing (e.g. forecasting resource needs); predicting future data storage requirements, etc. Further examples of feature extraction windows, target windows, training set for the feature set as relevant to inference and training stages was also discussed earlier with reference to FIGS. 1A and 1B. One example diagrammatic flow of training the first prediction model 154, the second prediction model 156 and third prediction model 158 is also shown in FIG. 1D.

In one optional example aspect, the operation 702 may include the following example process steps for the content delivery system 100, and particularly the prediction engine 114 for training and generating the first prediction model 154 applying gradient boosted regression learning, which initiates with initializing predictions. The model may initiate with a simple set of example predictions for all instances in the historical feature dataset, such as the average of the target variable. The model may then compute residuals to calculate the difference between the actual target values and the initial predictions. The model may then train a weak learner that aims to predict the residuals which may focus on capturing patterns in the data that were not well-represented by the initial predictions. The model may then be configured to update the model's predictions by adding the predictions of the decision tree to the initial predictions thus correcting the errors made by the initial predictions and calculating new residuals based on the updated predictions. These new residuals represent the remaining errors to be corrected. Such a process may be repeated for a specified number of iterations or until a stopping criterion is met. The final prediction for each instance is the sum of the initial predictions and the predictions from all the decision trees in the ensemble. In one example process, during the inference process, when a new set of input features for a new instance that needs a prediction is provided, then the input features may be passed through each decision tree in the ensemble of the prediction model such that each tree in the model contributes its prediction to the overall result and the sum of all of the predictions of all the decision trees may be used to obtain the final prediction for the new instance. The model may then correct errors by iteratively adjusting predictions in the direction that reduces the remaining error and the model may combine the prediction of multiple decision trees to create a more accurate and robust final prediction.

As described earlier, conveniently, the proposed machine learning system shown in the prediction engine 114 of FIG. 1D is specifically configured to utilize a set of machine learning models specifically trained to cooperate together to provide additional output information beyond the prediction including a numerical metric of confidence for the prediction by specifically retraining the existing prediction model (e.g. the first prediction model 154) in a specific manner as described earlier.

As noted earlier, in aspects of the operation 702, the first prediction model applied extreme gradient boosted and is generated by utilizing squared error loss as the loss function for regression tasks for predicting real-values variable given some input variables. Such loss function for the first prediction model may be defined as

$$L = {( y - X θ )}^{2}$$

As described earlier, the squared error loss is L, with y as the actual values, xθ as the prediction, whereby θ are the model parameters of the first prediction model (e.g. the first prediction model 154 of FIG. 1D) once trained such that when the value xθ as the prediction is bigger or smaller than y, then there is a loss which represents the errors between the prediction and the target such that the loss function is the square error loss.

In operation 704, the content delivery system 100 is configured to generate a second prediction model (e.g. the second prediction model 156 of FIG. 1D) which is directly coupled to the first prediction model once already trained at operation 704. In operation 706, the content delivery system 100 generates the second prediction model (e.g. the second prediction model 156 of the prediction engine 114 of FIG. 1D) by retraining the first prediction model previously trained (e.g. the first prediction model 154) in a subsequent iteration, based on an updated loss regression loss function by weighting by an upper bound metric for applying quantile regression for predicting an upper bound quantile of the variable (e.g. generating the second prediction model 156 to output an upper bound 161).

Put another way, in operation 704, the first prediction model 154 may be retrained with a different objective function or a different loss function. That is, the model operates by an objective function which penalizes when the prediction is far from the ground truth. In the case of the retraining with the upper quantile, the loss function is no longer symmetric, that is, the loss function utilizes τ=quantile of interest; whereby the content delivery system 100 may set τ=upper quantile=0.95 in the following loss function for the second prediction model 156 in predicting the upper bound quantile. Other variations of t may be envisaged to estimate the upper quantile depending on the particular application of the prediction engine 114 and/or accuracy of the prediction which may alter the feedback and thus the subsequent value of t used by the prediction engine 114.

$$L = \{ \begin{matrix}τ ( y - X θ ) , & if y - X θ \geq 0 \\ ( τ - 1 ) ( y - X θ ) , & if y - X θ < 0\end{matrix}$$

As described earlier, this loss function with τ=0.95; penalizes more when the model prediction underestimates thereby predicting the upper bound quantile, e.g. generating output upper bound 161.

In operation 708, the content delivery system 100 generates a third prediction model (e.g. see third prediction model 158 in FIG. 1D coupled to the first prediction model 154) coupled to the first prediction model once already trained.

In operation 710, the content delivery system 100 generates the third prediction model by retrained the existing first prediction model with a different loss function, that is based on the updated regression loss function but now weighted by a lower bound metric for applying quantile regression for prediction a lower bound quantile of the variable of interest. Put another way, the updated loss function is applied by the content delivery system 100 during retraining in a second branch as shown in FIG. 1D to generate the third prediction model (e.g. third prediction model 158) with the variable t set to a lower quantile amount which may be predefined in one or more databases of the content delivery system 100. In one example, τ=0.05 and thus the existing prediction model is retrained with the 5^{th} quantile as shown in FIG. 1D. Thus, the third prediction model may penalize more when the model prediction overestimates and does not penalize if the model underestimates thereby resulting in the lower bound, e.g. the output lower bound 163 as the retrained third prediction model is penalizing less when under predicting and more when over predicting.

In operation 712, the content delivery system 100 applies a range of output signals retrieved from the prediction models, including the upper bound quantile, the lower bound quantile and the target value of the prediction to a confidence predictor module (e.g. confidence predictor model 160) to predict as a function therefrom, a confidence score signal.

Notably, once the upper and lower bound quantiles are generated by the specifically retrained second and third prediction models, as discussed with reference to FIG. 1D, using a different loss function, the content delivery system 100 uses the outputs from the three different prediction models to determine, e.g. via a confidence predictor model 160, and provide an output signal indicative a numerical output of a degree of confidence in a given prediction generated by the prediction model using the upper and lower bound quantiles as follows:

$$Confidence = \frac{\hat{y}}{\vert uppe r bound - lower bound \vert}$$

In one aspect, the content delivery system may then compare the confidence score to a confidence cut-off or expected threshold as may be stored in one or more databases of the system (e.g. confidence score repository 128) as shown in operation 714.

In one or more embodiments, subsequent to operation 712 and based on generating the confidence score from the machine learning system, the system upon detecting the confidence level can automatically generate one or more computerized actions via an action generation module to be performed by a processor (e.g. processor 123 of the content delivery system) on one or more associated computing devices (e.g. content delivery system 100, client computing devices 102, data processing server 110, other computing devices of the environment 101, etc.) as may be defined in the confidence score repository and assigned with particular actions to be performed, such as when the environment 101 is processing one or more data transfers, electronic communications, transactions, etc. relating to the prediction (e.g. presenting on a user interface 106 information related to a particular prediction). Such actions may conveniently control errors in the prediction by managing and controlling subsequent actions to be taken (e.g. via the action generation module 120).

Examples of actions or notifications or alerts automatically generated by the system based on one or more triggers of the confidence score levels detected and to be taken by the content delivery system as described with reference to FIG. 1D, including but not limited to: preventing the prediction to be output to other computing devices (e.g. across the environment 101 of FIG. 1A), such as client computing devices in dependence upon the content delivery system detecting a low confidence score; updating the prediction models (e.g. the first prediction model) and associated hyper parameters based on a low confidence score being detected; applying high confidence predictions to the reinforce the first prediction model's training by providing accurate instances for positive reinforcement thereby causing continuous learning and improvement of the models; upon detecting a low confidence score, causing the first prediction model and thereby the second and third prediction models to be regenerated to prioritize attention on uncertain instances whereby confidence is detected as low; adjusting hyerparameters to optimize performance of the prediction models based on a high confidence prediction being detected, performing dynamic threshold adjustment by adjusting decision thresholds for the models based on the detected confidence score such that if a high confidence score is detected, the model may be more lenient in accepting the prediction; or the content delivery system causing certain resource allocations based on a high confidence prediction and triggering same in associated devices such as the client device; or upon detecting a high confidence score expediting approval of transactions related to the prediction and the predicted target variable such as causing transactions to occur for related products to the prediction across the environment 101 of FIG. 1A, etc.

In one or more aspects, the triggered actions generated by the system in response to the confidence score generated by the confidence machine learning models of FIG. 1D, which provide a proxy measure of confidence and variability output (e.g. via the second output 167 of FIG. 1D) may be used by the action generation module 120 in cooperation with the insight generation module 122 to determine the tone of the nudge content (e.g. forecast nudge content to be displayed on user interface 106 of client computing device 102 as shown in example of FIG. 2).

Other automatically generated computerized actions and variations of the described actions as determined by the action generation module of FIG. 1D within the computing environment of FIG. 1A and triggered in response to a detected signal indicating a confidence score may be envisaged as described herein.

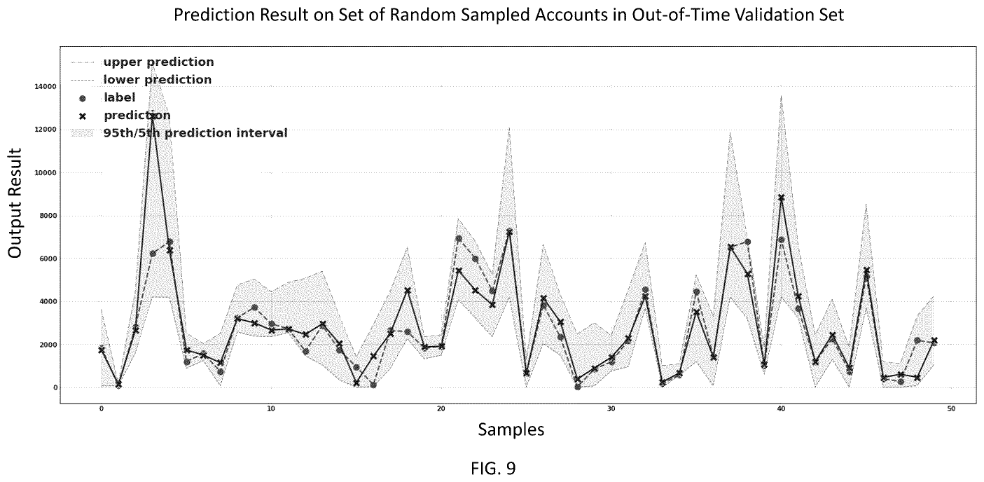

FIG. 9 illustrates an example graph of a prediction output result for a particular variable of interest on a set of random sampled accounts (e.g. prediction of future income values based on a set of 50 random sampled accounts) in out of time validation set, according to one embodiment, such as applying the prediction engine 114 of FIG. 1D of a content delivery system 100 of FIG. 1A to a data set. The x-axis depicts individual samples or accounts in the out of time validation set while the y-axis depicts output results (e.g. income values). As shown in the legend, the graph depicts, the upper bound prediction and the lower bound predictions (e.g. as provided from the second prediction model 156 and the third prediction model 158); along with the prediction (e.g. from the first prediction model 154). The data points illustrate both the predicted income levels predicted by the models and the labelled income represented by a different set of markers indicating actual income values for each account as per the ground truth labels in the data set. The graph of FIG. 9 illustrates a visual representation of how the prediction models perform on the out of time validation set and an example of the value of the upper and lower prediction outputs for improving performance of the machine learning models in the prediction engine 114.

While this specification contains many specifics, these should not be construed as limitations, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

Various embodiments have been described herein with reference to the accompanying drawings. It will, however, be evident that various modifications and changes may be made thereto, and additional embodiments may be implemented, without departing from the broader scope of the disclosed embodiments as set forth in the claims that follow. Further, other embodiments will be apparent to those skilled in the art from consideration of the specification and practice of one or more embodiments of the present disclosure. It is intended, therefore, that this disclosure and the examples herein be considered as exemplary only, with a true scope and spirit of the disclosed embodiments being indicated by the following listing of exemplary claims.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit.

Instructions may be executed by one or more processors, such as one or more general purpose microprocessors, application specific integrated circuits (ASICs), field programmable logic arrays (FPGAs), digital signal processors (DSPs), or other similar integrated or discrete logic circuitry. The term “processor,” as used herein may refer to any of the foregoing examples or any other suitable structure to implement the described techniques. In addition, in some aspects, the functionality described may be provided within dedicated software modules and/or hardware. Also, the techniques could be fully implemented in one or more circuits or logic elements. The techniques of this disclosure may be implemented in a wide variety of devices or apparatuses, an integrated circuit (IC) or a set of ICs (e.g., a chip set).

One or more currently preferred embodiments have been described by way of example. It will be apparent to persons skilled in the art that a number of variations and modifications can be made without departing from the scope of the invention as defined in the claims.

One or more currently preferred embodiments have been described by way of example. It will be apparent to persons skilled in the art that a number of variations and modifications can be made without departing from the scope of the invention as defined in the claims.

What is claimed is:

1. A system comprising:
a system of machine learning models, comprising:
a first prediction model trained via a set of historical features for predicting a future target value of a target variable at a future time from a current time having a related set of features and applying regression learning for predicting based on an initial loss function;
a second prediction model coupled to the first prediction model once already trained, the second prediction model for retraining the first prediction model, via configuration engine, in a subsequent iteration based on an updated regression loss function being weighted by an upper bound metric for applying quantile regression for predicting an upper bound quantile of the target variable being predicted;
a third prediction model coupled to the first prediction model once already trained, the third prediction model retraining the first prediction model in a further subsequent iteration, via the configuration engine, based on the updated regression loss function weighted by a lower bound metric for applying quantile regression for predicting a lower bound quantile of the target variable being predicted;
a confidence predictor module, coupled in communication with the first prediction model, the second prediction model and the third prediction model for receiving a range of outputs relating to the variable comprising the upper bound quantile, the lower bound quantile and the target value of the target variable and for predicting as a function therefrom, an output signal indicative of a confidence score; and
an action generation module coupled to the confidence predictor module for processing the output signal from the confidence predictor module and based on comparing the output signal to an expected signal threshold, triggering generation of a set of actions performed by the system on at least one associated computing device when processing transaction records associated with the target variable.

2. The system of claim 1, wherein the confidence predictor module determines the confidence score by applying:
$$Confidence = \frac{\hat{y}}{\vert uppe r bound - lower bound} = \frac{\hat{y}}{\vert {\hat{y}}_{upper} - {\hat{y}}_{lower} \vert}$$
where “ŷ” is prediction output of the first prediction model, “ŷᵤₚₚₑᵣ” is the upper bound quantile provided as output of the second prediction model and “ŷ_{lower}” is the lower bound quantile of the target variable provided as output of the third prediction model.

3. The system of claim 2 wherein the action generation module is in communication with the confidence predictor module, for triggering generation of a particular action upon receiving an indication of the output signal on the at least one associated computing device in response to detecting subsequent transactions on the at least one associated computing device related to the target variable, the actions retrieved from a confidence score repository based on a degree of confidence determined as a degree of deviation of the confidence score relative to the expected signal threshold.

4. The system of claim 3 wherein the third prediction model is configured, via the configuration engine, to increase a hyperparameter in the updated regression loss function of the third prediction model to penalize more on overestimated predictions to determine the lower bound quantile of the target variable.

5. The system of claim 4, wherein the second prediction model is configured, via the configuration engine, to decrease the hyperparameter associated with the second prediction model to penalize more on underestimated predictions to determine the upper bound quantile of the target variable.

6. The system of claim 5, wherein the second and third prediction models configured for retraining an existing machine learning prediction model provided by the first prediction model to cooperate together to determine a measure of confidence associated with predicting the future target value of the target variable, wherein the existing machine learning prediction model applies, via the configuration engine, a squared error prediction having a squared error loss objective defined by: L=(y−Xθ)², wherein y represents actual values of the target variable and Xθ represents predicted values, the loss function used to optimize the first prediction model to predict the future target value of the target variable.

7. The system of claim 6, wherein the second prediction model and the third prediction model are configured for adjusting a prior trained machine learning prediction model provided by the first prediction model to optimize a quantile loss function defining the updated regression loss function, wherein the quantile loss function is defined by:
$$L = \{ \begin{matrix}τ ( y - X θ ) , & if y - X θ \geq 0 \\ ( τ - 1 ) ( y - X θ ) , & if y - X θ < 0\end{matrix}$$
wherein τ∈(0, 1) specifies the τₜₕ quantile of interest, y is actual value of the target variable, Xθ is a hypothesis function defining prediction performed by a respective model which uses extreme gradient boosted (XGBoost) as a learning algorithm.

8. The system of claim 7, wherein the configuration engine is configured to set the quantile of interest to τ=0.05 for the lower bound metric to predict the lower bound quantile variable and set the upper bound metric to τ=0.95 for predicting the upper bound quantile variable.

9. The system of claim 1, wherein the first prediction model, the second prediction model and the third prediction model are extreme gradient boosted models.

10. The system of claim 3, wherein the action generation module is configured to perform the action comprising displaying actionable icons on a graphical user interface on a particular client device of the at least one associated computing device for modifying subsequent transactions between the particular client device and one or more other computing devices across a communication network.

11. The system of claim 10, wherein the action generation module is configured, based on the confidence score determined to push out a signal indicative of the target variable predicted to only a selected set of client computing devices based on the confidence score having beyond a defined amount above the expected signal threshold as retrieved from the confidence repository, along with the actionable icons displayed concurrently on the graphical user interface of the selected set of client computing devices.

12. A computer implemented method comprising:
training a first prediction model via a set of historical features for predicting a future target value of a variable at a future time from a current time having a related set of features and applying regression learning for predicting based on an initial loss function;
generating a second prediction model coupled to the first prediction model once already trained;
retraining, via a configuration engine, the first prediction model to generate the second prediction model in a subsequent iteration based on an updated regression loss function being weighted by an upper bound metric for applying quantile regression for predicting an upper bound quantile of the target variable being predicted;
generating a third prediction model coupled to the first prediction model once already trained;
retraining, via the configuration engine, the first prediction model to generate the third prediction model in a further subsequent iteration based on the updated regression loss function weighted by a lower bound metric for applying quantile regression for predicting a lower bound quantile of the target variable being predicted;
applying a range of outputs relating to the variable comprising the upper bound quantile, the lower bound quantile and the target value to a confidence predictor module coupled in communication with the first prediction model, the second prediction model and the third prediction model, to predict as a function therefrom, an output signal indicative of a confidence score; and
processing, by an action generation module coupled to the confidence predictor module, the output signal, for processing and based on comparing the output signal to an expected signal threshold, triggering generation of a set of actions performed by a processor on at least one associated computing device when processing transaction records associated with the target variable.

13. The method of claim 12, wherein determining the confidence score, via the confidence predictor module, comprises applying:
$$Confidence = \frac{\hat{y}}{\vert uppe r bound - lower bound} = \frac{\hat{y}}{\vert {\hat{y}}_{upper} - {\hat{y}}_{lower} \vert}$$
where “ŷ” is prediction output of the first prediction model, “ŷᵤₚₚₑᵣ” is the upper bound quantile provided as output of the second prediction model and “ŷ_{lower}” is the lower bound quantile of the target variable provided as output of the third prediction model.

14. The method of claim 13 wherein the action generation module is in communication with the confidence predictor module, and triggering generation of a particular action upon receiving an indication of the output signal on the at least one associated computing device comprises: in response to detecting subsequent transactions on the at least one associated computing device related to the target variable, retrieving the actions from a confidence score repository based on a degree of confidence determined as a degree of deviation of the confidence score relative to the expected signal threshold.

15. The method of claim 14 wherein the third prediction model is configured, via the configuration engine, to increase a hyperparameter in the updated regression loss function of the third prediction model to penalize more on overestimated predictions to determine the lower bound quantile of the target variable.

16. The method of claim 15, wherein the second prediction model is configured, via the configuration engine, to decrease the hyperparameter associated with the second prediction model to penalize more on underestimated predictions to determine the upper bound quantile of the target variable.

17. The method of claim 16, wherein the second and third prediction models configured for retraining an existing machine learning prediction model provided by the first prediction model to cooperate together to determine a measure of confidence associated with predicting the future target value of the target variable, wherein the existing machine learning prediction model applies, via the configuration engine, a squared error prediction having a squared error loss objective defined by: L=(y−Xθ)², wherein y represents actual values of the target variable and Xθ represents predicted values, the loss function used to optimize the first prediction model to predict the future target value of the target variable.

18. The method of claim 17, wherein the second prediction model and the third prediction model are configured for adjusting a prior trained machine learning prediction model provided by the first prediction model to optimize a quantile loss function defining the updated regression loss function, wherein the quantile loss function is defined by:
$$L = \{ \begin{matrix}τ ( y - X θ ) , & if y - X θ \geq 0 \\ ( τ - 1 ) ( y - X θ ) , & if y - X θ < 0\end{matrix}$$
wherein τ∈(0, 1) specifies the τₜₕ quantile of interest, y is actual value of the target variable, Xθ is a hypothesis function defining prediction performed by a respective model which uses extreme gradient boosted (XGBoost) as a learning algorithm.

19. The method of claim 18, wherein the configuration engine is configured to set the quantile of interest to τ=0.05 for the lower bound metric to predict the lower bound quantile variable and set the upper bound metric to τ=0.95 for predicting the upper bound quantile variable.

20. The method of claim 12, wherein the first prediction model, the second prediction model and the third prediction model are extreme gradient boosted models.

21. The method of claim 14, wherein the action generation module is configured to perform the action comprising displaying actionable icons on a graphical user interface on a particular client device of the at least one associated computing device for modifying subsequent transactions between the particular client device and one or more other computing devices across a communication network.

22. The method of claim 21, wherein the action generation module is configured, based on the confidence score determined to push out a signal indicative of the target variable predicted to only a selected set of client computing devices based on the confidence score having beyond a defined amount above the expected signal threshold as retrieved from the confidence repository, along with the actionable icons displayed concurrently on the graphical user interface of the selected set of client computing devices.

23. A tangible, non-transitory computer-readable medium storing instructions that, when executed by at least one processor, perform a method comprising:
training a first prediction model to generate a trained model via a set of historical features for predicting a future target value of a variable at a future time from a current time having a related set of features and applying regression learning for predicting based on an initial loss function;
generating a second prediction model coupled to the first prediction model once already trained;
retraining the first prediction model to generate the second prediction model in a subsequent iteration based on an updated regression loss function being weighted by an upper bound metric for applying quantile regression for predicting an upper bound quantile of the target variable being predicted;
generating a third prediction model coupled to the first prediction model once already trained;
retraining the first prediction model to generate the third prediction model in a further subsequent iteration based on the updated regression loss function weighted by a lower bound metric for applying quantile regression for predicting a lower bound quantile of the target variable being predicted;
applying a range of outputs relating to the variable comprising the upper bound quantile, the lower bound quantile and the target value to a confidence predictor module coupled in communication with the first prediction model, the second prediction model and the third prediction model, to predict as a function therefrom, an output signal indicative of a confidence score; and
processing the output signal at an action generation module couple to the confidence predictor module, for processing and based on comparing the output signal to an expected signal threshold, triggering generation of a set of actions performed by a processor on at least one associated computing device when processing transaction records associated with the target variable.
